(19) United States
(12) Patent Application Publication
(10) Pub. No.: US 2020/0165130 A1
(43) Pub. Date: May 28, 2020

(54) ELECTRIDES, ARTICLES, AND METHODS OF MAKING THE SAME

(71) Applicant: THE UNIVERSITY OF NORTH CAROLINA AT CHAPEL HILL, Chapel Hill, NC (US)

(72) Inventors: Scott Warren, Chapel Hill, NC (US); Daniel L Druffel, Carrboro, NC (US); Kaci L Kuntz, Chapel Hill, NC (US); Adam H Woomer, Durham, NC (US); Jun Hu, Chapel Hill, NC (US)

(21) Appl. No.: 16/305,325

(22) PCT Filed: Jun. 2, 2017
(86) PCT No.: PCT/US17/35732

§ 371 Date: Nov. 28, 2018

Related U.S. Application Data
(60) Provisional application No. 62/344,774, filed on Jun. 2, 2016.

(51) Int. Cl. C01B 21/06; H01B 1/06

(52) U.S. Cl. CPC C01B 21/0612; C01P 2002/72; C01P 2002/20; C01P 2004/24; C01P 2006/12; C01P 2002/76; C01P 2002/78; C01P 2004/54; C01P 2006/40; C01P 2006/60; C01P 2002/77; C01P 2004/04; C01P 2002/74; C01P 2002/85; H01B 1/06

(57) ABSTRACT

The invention generally relates to electrides and methods of making thereof. More specifically, the invention relates to a crystalline electride comprising: at least one positively charged layer comprising at least one alkaline earth metal subnitride represented by a formula A₂N, wherein A comprises Mg, Sr, Ba, Ca, or a combination thereof, and one or more layers of anionic electrons; and having a thickness from greater than 0 nm to about 50 nm. Further, methods of making these electrides are further disclosed. This abstract is intended as a scanning tool for purposes of searching in the particular art and is not intended to be limiting of the present invention.

### CROSS-REFERENCE TO RELATED APPLICATIONS

This application claims benefit of U.S. Provisional Application No. 62/344,774, filed on Jun. 2, 2016, which is hereby incorporated by reference in its entirety.

### STATEMENT REGARDING FEDERALLY SPONSORED RESEARCH

This invention was made with government support under grant number DMR-1429407 and DMR-161769, awarded by the National Science Foundation (NSF) and under grant No. DGE-1144081 awarded by NSF Graduate Research Fellowship. The government has certain rights in the invention.

### BACKGROUND

Materials with properties such as high electronic conductivity, variable thermal conductivity, high optical transparency and catalytic activity became essential components of industrially relevant processes and devices, such as various catalytic properties, electronic materials (e.g., transistors and sensors, and the like), electrochromic materials (e.g., windows), electrocatalysts (e.g., in fuel cells and other energy storage systems), and magnetic devices (e.g., some classes of memory storage devices). Though extant materials possess properties for performing functions in these material categories, there is a continual search for new materials that may outperform, provide better value than, or provide additional functionality over these materials.

Diodes, transistors, and circuits derived from the combination of these electronic materials have enabled the enormous advances in high impact technology areas, including information processing, computing, consumer electronics, molecular electronics, aerospace technologies, and medical technologies.

Some of these devices have been conventionally constructed from semiconductors—principally silicon—because the p-n junctions that define charge transport can be fabricated with exceptional reliability at a low cost while achieving ever-increasing performance characteristics. In these devices, the role of metals has been principally relegated to that of electronic interconnects because unlike a p-n junction, which exhibits non-linear current-voltage (i-v) characteristics, metallic materials exhibit Ohmic (linear) behavior. Even at the nanoscale level—whether as nanosheets, nanowires, or nanoparticles—metals and materials having metallic character retain their linear current-voltage characteristics and therefore act as current carriers with constant resistance under typical operating conditions.

Other electronic devices such as flat panel displays, for example, an LCD or LED, a touch screen panel, a solar cell, a transparent transistor, and the like, also include a transparent electrically conductive film. It is desirable for a material of an electrically conductive film to have high light transmittance (e.g., greater than or equal to about 80% in a visible light region) and low specific resistance (e.g., less than or equal to about 1×10⁻³ Ω*cm). Currently available materials for transparent and electrically conductive films include indium tin oxide (ITO), tin oxide (SnO₂), zinc oxide (ZnO), and the like. However, these materials also have significant limitations. For example, it is known that the ITO has poor flexibility and limited reserves of the indium may introduce an additional financial burden on the industry. Therefore, development of an alternative material is desired.

Thus, there is still a need for materials having improved electrical, thermal, and optical properties. Still there is a need for materials having high electrical conductivity, variable thermal conductivity and optical transparence.

### SUMMARY

In accordance with the purpose(s) of the invention, as embodied and broadly described herein, the invention, in one aspect, relates to a crystalline electride comprising: at least one positively charged layer comprising at least one alkaline earth metal subnitride represented by a formula A₂N, wherein A comprises Mg, Sr, Ba, Ca, or a combination thereof, and one or more layers of anionic electrons; and having a thickness from greater than 0 nm to about 50 nm.

In yet other aspects, the invention relates to a composition comprising (a) at least one positively charged layer comprising at least one alkaline earth metal subnitride represented by a formula A₂N, wherein A comprises Mg, Sr, Ba, Ca, or a combination thereof, and one or more layers of anionic electrons; and (b) a solvent, wherein the crystalline electride does not substantially react with the solvent for a period of time of at least 48 hours

Also disclosed are methods comprising: (a) contacting a compound represented by a formula A₂N, wherein A comprises Mg, Sr, Ba, Ca, or a combination thereof, with a solvent that does not substantially react with the solvent for a period of time of at least 48 hours; and (b) exfoliating a crystalline electride comprising at least one positively charged layer comprising at least one alkaline earth metal subnitride represented by a formula A₂N, wherein A comprises Mg, Sr, Ba, Ca, or a combination thereof, and one or more layers of anionic electrons.

Also disclosed herein are products produced by the inventive methods. Also disclosed are articles comprising an inventive electride.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

### BRIEF DESCRIPTION OF THE DRAWINGS

The accompanying figures, which are incorporated in and constitute a part of this specification, illustrate several aspects and together with the description serve to explain the principles of the invention.

FIG. 1 depicts (a) the unit cell of Ca₂N depicting layers of [Ca₂N]⁺ that alternate with layers of delocalized electrons; b) projection of the integrated electron density in the unit cell as calculated by density functional theory (DFT). The integration is over occupied states in the highest occupied band; c) the electron density profile integrated along the z-axis of the unit cell for the occupied band shown in (b); d) interlayer binding energy versus interlayer distance, as calculated by DFT; e) photos of Ca₂N bulk powder and 2D Ca₂N suspensions in 1,3-dioxolane and tetrahydrofuran (THF).

FIG. 2 depicts a) high resolution TEM image of 2D Ca₂N showing the sheet-like morphology and crystallinity; b) diffraction pattern of 2D Ca₂N with the low resolution TEM image of the corresponding 2D flake; simulated diffraction pattern of (c) bilayer Ca₂N and (d) Ca₂N with translational disorder looking down the [001] zone axis; e) comparison of the relative intensity of the spots at 3.21 nm⁻¹ to the spots at 5.56 nm⁻¹ in the simulated diffraction patterns for different thicknesses of 2D Ca₂N.

FIG. 3 depicts a) XPS spectra of core Ca 2p electrons for 2D Ca₂N, deliberately oxidized 2D Ca₂N, Ca₃N₂, and Ca(OH)₂; b) XPS spectra of core N is electrons for 2D Ca₂N and Ca(OH)₂. c) Ultraviolet photoemission spectroscopy Fermi edge of the metallic 2D Ca₂N.

FIG. 4 depicts a) photo of a cuvette containing 2D Ca₂N suspended in 1,3-dioxolane in front of the University of North Carolina logo; b) the attenuation coefficient and molar extinction coefficient of 2D Ca₂N vs. the wavelength of light; the inset of (b) shows a photo of a cuvette containing concentrated 2D Ca₂N and its absorbance spectrum; the short-wavelength response (300-800 nm) comparing c) the attenuation coefficient a of 2D Ca₂N, d) the joint density of states calculated by density functional theory for 2D Ca₂N, e) the attenuation coefficient a of 3D Ca₂N calculated from literature data; f) the band structure of Ca₂N; projection of the integrated electron density in the unit cell integrated over g) states in the flat band (shown as 1 in 0 and over states in the band (shown as 2 in 0 above the Fermi level. The scale bars for g and h are 0.00 to 1.49×10⁻³ e⁻ Å⁻³ and 0.00 to 0.12×10⁻³ e⁻ Å⁻³, respectively.

FIG. 5 depicts a Powder X-ray diffraction pattern of synthesized Ca₂N compared to a simulation of the diffraction pattern using crystal parameters, reported in Gregory, D. H.; Bowman, A.; Baker, C. F.; Weston, D. P. J. Mater. Chem. 2000, 10, 1635.

FIG. 6 depicts an electronic structure of mono- and bilayer Ca₂N: a) band structure of monolayer Ca₂N calculated from the hexagonal unit cell. Projections of the integrated electron density of monolayer Ca₂N within the unit cell as calculated by density functional theory (DFT). The integration is over states in the energy range b) −1.41 eV (line marked 1) to E_{F} and c) −0.39 eV (line marked 2) to E_{F}. The greyscale gradient in (b) and (c) ranges from an electron density of 0.00 (medium gray, 1) to 0.05×10⁻³ (dark grey) to 0.10×10⁻³ e⁻ Å⁻³ (light grey, 2). d) The electron density profile integrated along the z-axis of the unit cell for the states in b and c. e) The joint density of states (JDOS) for monolayer Ca₂N. f) Band structure of bilayer Ca₂N calculated from the hexagonal unit cell. Projections of the electron density of bilayer Ca₂N integrated over states in the energy range g) −1.88 eV (linel) to E_{F}, h) −0.90 eV (line 2) to E_{F}, and i) −0.56 eV (line 3) to E_{F} (line 4). The greyscale gradient in g, h, and i varies from 0.00 (medium grey) to 0.20×10⁻³ (dark grey) to 0.41×10⁻³ e⁻ Å⁻³ (light grey), 0.00 (medium grey) to 0.07×10⁻³ (dark grey) to 0.14×10⁻³ e⁻ Å⁻³ (light grey), and 0.00 (medium grey) to 0.07×10⁻³ (dark grey) to 0.14×10⁻³ e⁻ Å⁻³ (light grey), respectively. j) The electron density profile integrated along the z-axis of the unit cell for the states in g, h and i. k) The JDOS for bilayer Ca₂N.

FIG. 7 depicts a Powder X-ray diffraction pattern of Ca(OH)₂ and Ca₂N exposed to THF for 24 hours.

FIG. 8 depicts low-resolution transmission electron microscopy images of flakes of 2D Ca₂N.

FIG. 9 depicts a simulated diffraction pattern of a) monolayer Ca₂N, b) trilayer Ca₂N, c) Ca₂N with stacking sequence ABC-ABC-ABA-ABC-ABC, d) Ca₂N with stacking sequence ACC-ACC-ABA-CBB-BAB looking down the [001] zone axis.

FIG. 10 depicts an XPS spectra of core C is electrons for 2D Ca₂N, deliberately oxidized 2D Ca₂N, and Ca(OH)₂.

FIG. 11 depicts photoemission spectroscopy images of a thick film of 2D Ca₂N on a platinum-coated silicon wafer. After sputtering the film with argon ions to remove surface contamination, the film was characterized. In XPS, (a) the carbon content on the surface of 2D Ca₂N decreased as sputtering time increased from 15 minutes (1) to 30 minutes (2). (b) The Pt film is almost entirely covered by Ca₂N, as shown by the extremely small peaks at 71.1 and 74.4 eV. The dashed line shows the positions of a bare Pt substrate; the intensities of the dashed line were reduced by a factor of 30. The inset shows a magnified version of the intensities for the Pt core electron binding energies on the film with 2D Ca₂N, showing that the Pt signal does not increase with sputtering time. (c) The calcium and (d) nitrogen peaks increase in area as hydrocarbons are removed by sputtering. (e) In UPS measurements, as hydrocarbons are removed, the density of states at the Fermi edge become more prominent and provides evidence for the metallic character of 2D Ca₂N.

FIG. 12 depicts differential charging of samples of 2D Ca₂N. a) XPS spectra of bulk Ca₂N Ca 2p electrons with the charge neutralizer on (1) and with the charge neutralizer off (2). b) UPS spectra of bulk Ca₂N with 5V (3), 10V (4), 15V (5), and 20V (6) applied biases at the secondary cut-off energy, E_{SECO}. The spectra are corrected to account for the different applied biases. (c) Work function, ϕ, plotted against the applied bias for one sample of 2D Ca₂N.

FIG. 13 depicts the absorbance of suspensions of 2D Ca₂N vs. wavelength. The solvent has been background subtracted. The inset shows that the absorbance depends linearly on the concentration across the UV-Vis-IR range.

FIG. 14 depicts a) The band structure of Ca₂N highlighting the flat band of states with energies of −1.72 eV to −1.5 eV (1) and the unfilled states in the conduction band with energies 0 eV to 1.00 eV (2). Arrows (3) depict direct transitions from the flat band to the conduction band. b) The joint density of states (JDOS) for the entire band structure (4) and for only the transitions from the flat band to the conduction band (3). The relative contribution of those transitions to the total JDOS is shown as line 5.

FIG. 15 depicts a schematic of the measurement with the sample a) in front of the integrating sphere and b) inside of the integrating sphere. The UV-vis-NIR absorbance spectra of Ca₂N vs. wavelength with the sample in different geometries. The solvent used as a background.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such may, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein may be different from the actual publication dates, which can require independent confirmation.

### Definitions

As used herein, nomenclature for compounds, including organic compounds, can be given using common names, IUPAC, IUBMB, or CAS recommendations for nomenclature.

As used in the specification and the appended claims, the singular forms “a,” “an” and “the” include plural referents unless the context clearly dictates otherwise. Thus, for example, reference to “a flake,” “a film,” or “an article” includes two or more such substrates, films, articles, and the like.

Ranges can be expressed herein as from “about” one particular value, and/or to “about” another particular value. When such a range is expressed, a further aspect includes from the one particular value and/or to the other particular value. Similarly, when values are expressed as approximations, by use of the antecedent “about,” it will be understood that the particular value forms a further aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

References in the specification and concluding claims to parts by weight of a particular element or component in a composition denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (wt. %) of a component, unless specifically stated to the contrary, is based on the total weight of the formulation or composition in which the component is included.

All percentages, ratios and proportions herein are by weight, unless otherwise specified. All temperatures are in degrees Celsius (° C.) unless otherwise specified.

Throughout the description and claims of this specification the word “comprise” and other forms of the word, such as “comprising” and “comprises,” means including but not limited to, and is not intended to exclude, for example, other additives, components, integers, or steps.

As used herein, the term “substantially” means that the subsequently described event or circumstance completely occurs or that the subsequently described event or circumstance generally, typically, or approximately occurs. For example, when the specification discloses that the solvent does not substantially react with the crystalline electride, a person skilled in the relevant art would readily understand that the reaction does not have to be fully absent. Rather, this term conveys to a person skilled in the relevant art that the reaction between the solvent and the electride can be present to an extent that does not hinder desirable results or causes adverse effects.

As used herein, the term “transparent conductive oxide” generally refers to a film comprising a metal or metal combinations, A, combined with a nonmetal part, B, comprising of oxygen, and having a generic formula A_{y}B_{z}. It is understood that A_{y}B_{z} compounds have semiconductor properties and various opt-electrical characteristics. In some aspects, the opto-electrical characteristics can be changed by doping, A_{y}B_{z}:D (D=dopant), with metals, metalloids, or nonmetals.

As used herein, the term “transparent conductive film” generally refers to films comprising transparent conductive oxides, conductive polymers, metal grids, carbon nanotube (CNT), graphene, electrides, nanowire meshes, ultra-thin metal films, and the like.

As used herein, the terms “optional” or “optionally” means that the subsequently described event or circumstance can or cannot occur, and that the description includes instances where said event or circumstance occurs and instances where it does not.

As used herein, the terms “nanoparticles,” “nanosheets,” or “nanofilms” refer to particles, sheets, or films having nanoscale dimensions, for example dimensions greater than 0 nm and up to 500 nm.

As used herein, the term “particle” refers to a small localized object to which can be ascribed several physical or chemical properties, for example, volume or mass. It is further understood the particle can be described by a length, width, and thickness. It is understood that the term particle refers to the object having both length and width substantially the same as its thickness, within no more than 1.25 times of its thickness, within no more than 1.5 times of its thickness, within no more than 1.75 times of its thickness, within no more than 2 times of its thickness, within no more than 2.25 times of its thickness, within no more than 2.5 times of its thickness, within no more than 2.75 times of its thickness, within no more than 3 times of its thickness, within no more than 3.25 times of its thickness, within no more than 3.5 times of its thickness, within no more than 3.75 times of its thickness, within no more than 4 times of its thickness, within no more than 4.25 times of its thickness, within no more than 4.5 times of its thickness, within no more than 4.75 times of its thickness, or within no more than 5 times of its thickness.

As used herein, the term “flake” refers to a small, flat, thin piece of material that, in certain aspects, has been peeled off from a larger piece. It is understood that the flake as described herein can be further described by a length, width, and thickness. It is further understood that the flake can be described as a flat material, in which its length is at least 3 times of its thickness, at least 3.5 times of its thickness, at least 4 times of its thickness, at least 5 times of its thickness, at least 6 times of its thickness, at least 7 times of its thickness, at least 8 times of its thickness, at least 9 times of its thickness, at least 10 times of its thickness, at least 25 times of its thickness, at least 50 times of its thickness, at least 100 times of its thickness, at least 500 times of its thickness, or at least 1000 times of its thickness, while its width is substantially the same as its thickness, within no more than 1.25 times of its thickness, within no more than 1.5 times of its thickness, within no more than 1.75 times of its thickness, within no more than 2 times of its thickness, within no more than 2.25 times of its thickness, within no more than 2.5 times of its thickness, within no more than 2.75 times of its thickness, within no more than 3 times of its thickness, within no more than 3.25 times of its thickness, within no more than 3.5 times of its thickness, within no more than 3.75 times of its thickness, within no more than 4 times of its thickness, within no more than 4.25 times of its thickness, within no more than 4.5 times of its thickness, within no more than 4.75 times of its thickness, or within no more than 5 times of its thickness.

As used herein, the term “film” refers to a thin strip or plane of material. It is understood that the film as described herein can be further described by a length, width, and thickness. It is further understood that the film can be described as a flat material, in which length and width are both at least 5 times of its thickness. For example, the length can be at least 5 times the thickness, at least 5.5 times the thickness, at least 6 times the thickness, at least 7 times the thickness, at least 8 times the thickness, at least 9 times the thickness, at least 10 times the thickness, at least 25 times of its thickness, at least 50 times of its thickness, at least 100 times of its thickness, at least 500 times of its thickness, or at least 1000 times of its thickness. As further examples, the width can be at least 3 times the thickness, at least 3.5 times the thickness, at least 4 times the thickness, at least 5 times the thickness, at least 6 times the thickness, at least 7 times the thickness, at least 8 times the thickness, at least 9 times the thickness, at least 10 times the thickness, at least 25 times of its thickness, at least 50 times of its thickness, at least 100 times of its thickness, at least 500 times of its thickness, or at least 1000 times of its thickness.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”). As used herein the term “and/or” includes any and all combinations of one or more of the associated listed items.

It will be understood that, although the terms “first,” “second,” etc. may be used herein to describe various elements, components, regions, layers and/or sections. These elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

As used herein, the term “subnitride” refers to a class of nitrides wherein the electropositive element (e.g., a metal element) is in excess relative to the “normal” nitrides.

As used herein, the term or phrase “effective,” “effective amount,” or “conditions effective to” refers to such amount or condition that is capable of performing the function or property for which an effective amount is expressed. As will be pointed out below, the exact amount or particular condition required will vary from one aspect to another, depending on recognized variables such as the materials employed and the processing conditions observed. Thus, it is not always possible to specify an exact “effective amount” or “condition effective to.” However, it should be understood that an appropriate effective amount will be readily determined by one of ordinary skill in the art using only routine experimentation.

As used herein the term “transparent film” refers to a film having the property of transmitting light without substantial scattering.

As used herein the term “conductive film” refers to electrically conductive films.

As used herein the term “sheet resistance” refers to a measure of resistance of thin films that are substantially uniform in thickness. In some aspects, the sheet resistance can be used to evaluate film conductivity.

As used herein the term “solvent” refers to a component of a solution that is present in the greatest amount. It is further understood that solvent as described is the substance in which the solute is dissolved. It is understood that the term solvent as used herein should not be used in its narrow meaning that all solute in the solvent is fully dissolved. It would be clear to one of ordinary skill in the art that the solvent as described herein does not necessary fully dissolves the solute. In some embodiments, the solvent is inert to the solute and substantially no dissolution of the solute is observed. In other embodiments, the solvent can form a suspension with the solute. In still further embodiment, the solvent can react with the solute to produce a chemical reaction and form a new product. It is further understood that the solvent described herein can be any solvent known in the art and can include a liquid, gas, supercritical fluid, and solid. It is also understood that the solvents described herein can be liquid. The liquid solvents can be organic or inorganic, polar or non-polar, protic, aprotic, basic, acidic, or amphoteric.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

### Electrides

Electrides can be separated into two categories, organic and inorganic. Organic electrides are crystallized from an alkali or alkaline metal and a complexant, like crown ether. The packing of the complexed cations, which produce an image-positive charge in the cavities between cations, provide natural traps for anionic electronic charges. However, as one of ordinary skill in the art would readily appreciate these materials are highly unstable and decompose autocatalytically. Like their organic counterparts, inorganic electrides provide a framework, in this case a lattice of inorganic atoms, that forms an image-positive charge in cavities filled by anionic electrons. The two most important inorganic frameworks are nanoporous cage-structures like 12CaO.7Al₂O₃, in which anionic electrons are trapped in 1D cages, and layered electrides like Ca₂N in which electrons are trapped in 2D planes.

This disclosure relates to a crystalline electride comprising: at least one positively charged layer comprising at least one alkaline earth metal subnitride represented by a formula A₂N, wherein A comprises Mg, Sr, Ba, Ca, or a combination thereof, and one or more layers of anionic electrons; and having a thickness from greater than 0 nm to about 50 nm. In yet other aspects, the disclosed electrides can have a thickness from greater than 0 nm, about 1 nm, about 2 nm, about 5 nm, about 8 nm, about 10 nm, about 12 nm, about 15 nm, about 18 nm, about 20 nm, about 22 nm, about 25 nm, about 28 nm, about 30 nm, about 32 nm, about 35 nm, about 38 nm, about 40 nm, about 42 nm, about 45 nm, about 48 nm, or about 50 nm.

In certain aspects, the electrides can have a cage structure, in which anionic electrons are located within zero-dimensional cages. In other aspects, the electrides can have a layered structure.

In certain aspects, the positively charges layer comprises at least one alkaline earth metal subnitride Ca₂N. In other aspects, the positively charges layer comprises at least one alkaline earth metal subnitride Mg₂N. In yet other aspects, the positively charges layer comprises at least one alkaline earth metal subnitride Ba₂N. In still further aspects, the positively charges layer comprises at least one alkaline earth metal subnitride Sr₂N. In yet further aspects, the positively charges layer comprises a combination of alkaline earth metal subnitrides disclosed herein.

In yet other aspects, the electride described herein comprises one positively charged layer. In certain aspects, wherein one positively charged layer is present, one or two layers of anionic electrons is also present. In such aspects, the layer of anionic electrons can be present substantially near the surface of the positively charged layer.

In still further aspects, at least two layers of anionic electrons can be present, wherein the one positively charged layer is present. In such aspects, these two layers of anionic electrons can form a surface electron gas surrounding at least one positively charged layer. In yet other aspects, it is understood that the one or more layers of anionic electrons can form a surface electron gas surrounding at least one positively charged layer.

In still further aspects, three positively charged layers are present, wherein two anionic electrons layers disposed in interlayer space between the two or more positively charged layers.

In some aspects, the electride as described herein can comprise two or more positively charged layers and one layer of anionic electrons disposed in interlayer space between the two or more positively charged layers.

In other aspects, in the electrides having layered structures, the anionic electrons can be found in two-dimensional (2D) planes. In certain aspects, in layered electrides, the proximity of the anionic electrons causes them to partially delocalize as a 2D electron gas. The electron gas enables high electrical mobility, high carrier concentrations, and rapid electrical transport to the material's surfaces.

In certain aspects, the electrical mobility can be from about 0.01 to about 5000 cm² V⁻¹ s⁻¹ at room temperature. In yet other aspects, the electrical mobility is about 1, about 10, about 160 cm² V⁻¹ s⁻¹, about 500 at room temperature.

In certain aspects, the carrier concentration in the inventive electrides is from about 10²¹ to about 10²³ cm⁻³. In still further aspects, the carrier concentration is about 6×10²¹ cm⁻³, about 1.4×10²² cm⁻³, about 4×10²² cm⁻³.

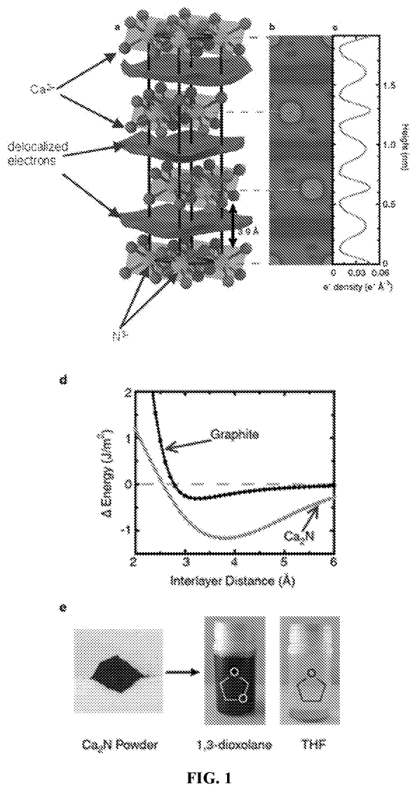

In an exemplary embodiment depicted in FIG. 1, the crystal structure of Ca₂N is shown. In this aspect, planes of Ca₆N octahedra are separated by a 3.9 Å interlayer gap. It is understood that due to the formal oxidation states of Ca²⁺ and N³⁻, the formula unit has a positive charge and is best represented as [Ca₂N]⁺. Anionic electrons balance the positive charge of the [Ca2N]⁺ layers by occupying the interlayer gap. It is understood that in some aspects, the anionic electrons are present in a stoichiometric relation with the positively charged layers to ensure net neutrality of the electride. The projections of electron density for the highest occupied band (−1.49 eV to EF, the Fermi level) shown in FIG. 1(b) were calculated using DFT model as described in details in the experimental portion of this specification. An electron density profile was provided with respect to the z-axis of the hexagonal unit cell for this band (FIG. 1(c)). In certain aspects, the interlayer electron gas consists of ca. 0.7 electrons per formula unit. In other aspects, the bands below the highest occupied band do not contribute additional electron density to the interlayer electron gas.

In some aspects, the electride described herein has a surface area from about 20 to about 2,500 m²/g, including exemplary values of about 30 m²/g, about 50 m²/g, about 70 m²/g, about 100 m²/g, about 150 m²/g, about 200 m²/g, about 250 m²/g, about 300 m²/g, about 350 m²/g, about 400 m²/g, about 450 m²/g, about 500 m²/g, about 550 m²/g, about 600 m²/g, about 650 m²/g, about 700 m²/g, about 750 m²/g, about 800 m²/g, about 850 m²/g, about 900 m²/g, about 950 m²/g, about 1,000 m²/g, about 1,050 m²/g, about 1,100 m²/g, about 1,150 m²/g, about 1,200 m²/g, about 1,250 m²/g, about 1,300 m²/g, about 1,350 m²/g, about 1,400 m²/g, about 1,450 m²/g, about 1,500 m²/g, about 1,600 m²/g, about 1,700 m²/g, about 1,800 m²/g, about 1,900 m²/g, about 2,000 m²/g, about 2,100 m²/g, about 2,200 m²/g, about 2,300 m²/g, and about 2,400 m²/g.

In some aspects, the electride is present as a film having a length from greater than 0 nm to about 100 μm, including exemplary values of about 5 nm, about 10 nm, about 20 nm, about 30 nm, about 40 nm, about 50 nm, about 60 nm, about 100 nm, about 150 nm, about 200 nm, about 250 nm, about 300 nm, about 400 nm, about 500 nm, about 600 nm, about 700 nm, about 800 nm, about 900 nm, about 1 μm, about 2 μm, about 3 μm, about 4 μm, about 5 μm, about 6 μm, about 7 μm, about 8 μm, about 9 μm, about 10 μm, about 20 μm, about 30 μm, about 40 μm, about 50 μm, about 60 μm, about 70 μm, about 80 μm, and about 90 μm. It is understood that the electride can have any length between the any two foregoing values.

In yet other aspects, the electride is present as a film having a width from greater than 0 nm to about 100 μm, including exemplary values of about 3 nm, about 10 nm, about 20 nm, about 30 nm, about 40 nm, about 50 nm, about 60 nm, about 100 nm, about 150 nm, about 200 nm, about 250 nm, about 300 nm, about 400 nm, about 500 nm, about 600 nm, about 700 nm, about 800 nm, about 900 nm, about 1 μm, about 2 μm, about 3 μm, about 4 μm, about 5 μm, about 6 μm, about 7 μm, about 8 μm about 9 μm, about 10 μm, about 20 μm, about 30 μm, about 40 μm, about 50 μm, about 60 μm, about 70 μm, about 80 μm, and about 90 μm. It is understood that the electride can have any width between the any two foregoing values.

In still further aspects, electride is present as a film having a width from greater than 0 nm to about 100 μm and a length from greater than 0 nm to about 100 μm, wherein each of the width and the length can have any values between any two foregoing values.

In still further aspects, the electride is present as a flake having a length from greater than 0 nm to about 100 μm, including exemplary values of about 3 nm, about 10 nm, about 20 nm, about 30 nm, about 40 nm, about 50 nm, about 60 nm, about 100 nm, about 150 nm, about 200 nm, about 250 nm, about 300 nm, about 400 nm, about 500 nm, about 600 nm, about 700 nm, about 800 nm, about 900 nm, about 1 μm, about 2 μm, about 3 μm, about 4 μm, about 5 μm, about 6 μm, about 7 μm, about 8 μm, about 9 μm, about 10 μm, about 20 μm, about 30 μm, about 40 μm, about 50 μm, about 60 μm, about 70 μm, about 80 μm, and about 90 μm. It is understood that the electride can have any length between the any two foregoing values.

In still further aspects, the electride is present as a flake having a width from greater than 0 nm to about 100 μm, including exemplary values 3 nm, about 10 nm, about 20 nm, about 30 nm, about 40 nm, about 50 nm, about 60 nm, about 100 nm, about 150 nm, about 200 nm, about 250 nm, about 300 nm, about 400 nm, about 500 nm, about 600 nm, about 700 nm, about 800 nm, about 900 nm, about 1 μm, about 2 μm, about 3 μm, about 4 μm, about 5 μm, about 6 μm, about 7 μm, about 8 μm about 9 μm, about 10 μm, about 20 μm, about 30 μm, about 40 μm, about 50 μm, about 60 μm, about 70 μm, about 80 μm, and about 90 μm It is understood that the electride can have any width between the any two foregoing values.

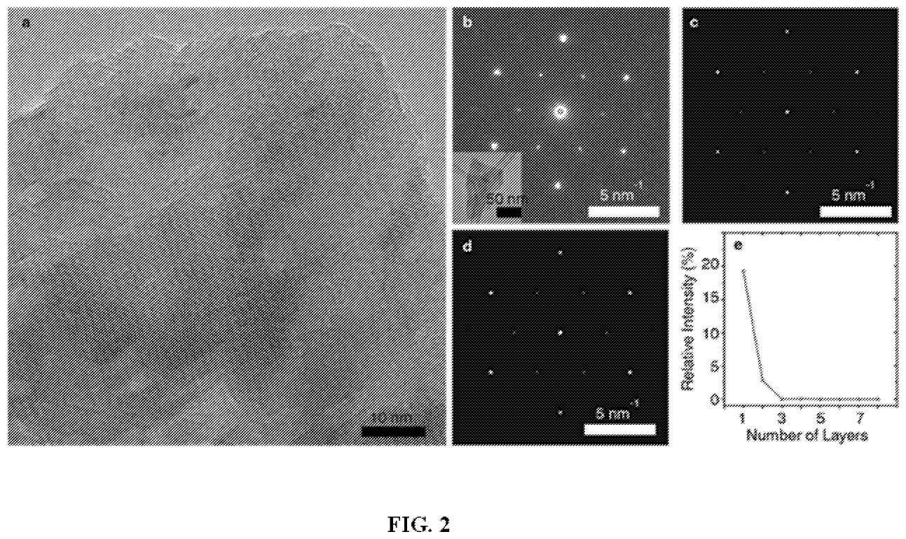

FIG. 2(a) shows a high-resolution transmission electron microscope (HR-TEM) image of an exemplary nanosheet of Ca₂N. In these aspects, the material is a single crystal and crystalline out to the edges of the flake. In some aspects, the inventive nanosheet material is flat and transparent to electrons. In other aspects, the layered electride can be a non-sheet-like. In yet other aspects, the layered electride can be an aggregate of sheets.

It is further understood that the electride described herein can have any distribution of lateral dimensions as described above and the thickness as disclosed.

In some aspects, the inventive electride, present as a film, has a length and a width of at least one order of magnitude larger than the thickness. In yet other aspects, the inventive electride has a length and a width of at least 2, at least 3, at least 4, or at least 5 orders of magnitude higher than its thickness.

In still further aspects, the inventive electride, present as a film or a flake, has an aspect ratio of at least about 1:2, at least about 1:3, at least about 1:4, at least about 1:5, at least about 1:10, at least about 1:15, at least about 1:20, at least about 1:30, or at least about 1:50.

In still further aspects, the inventive electride, present as a film or a flake, has a lateral size of at least about 10 nm, at least about 50 nm, at least about 100 nm, at least about 200 nm, at least about 300 nm, at least about 400 nm, at least about 500 nm, at least about 600 nm, at least about 700 nm, at least about 800 nm, at least about 900 nm, at least about 1 μm, at least about 5 μm, at least about 10 μm, at least about 20 μm, at least about 30 μm, at least about 40 μm, at least about 50 μm, at least about 60 μm, at least about 70 μm, at least about 80 μm, at least about 90 μm, or at least about 100 μm.

In still further aspects, the inventive electrides can be present as a solution. In these aspects, the inventive electrides particles, flakes or films can be dissolved in the solvent to form a solution. In certain aspects, the solution is a suspension of the electrides in the solvent. In still further aspects, the disclosed electrides are present as suspension.

In still further aspects, also disclosed a composition comprising: (a) at least one positively charged layer comprising at least one alkaline earth metal subnitride represented by a formula A₂N, wherein A comprises Mg, Sr, Ba, Ca, or a combination thereof, and one or more layers of anionic electrons; and (b) a solvent, wherein the crystalline electride does not substantially react with the solvent for a period of time of at least 48 hours.

In certain aspects, the solvents can be any solvents known in the art. In certain aspects, the solvents can comprise 1,3-dioxolane, dimethyl carbonate, dimethoxy ethane, toluene, hexane, benzene, benzyl benzoate, N-Methyl-2-pyrrolidone, ethylene carbonate, propylene carbonate, ionic liquids, 1-Octyl-2-pyrollidone, N-Vinyl-pyrrolidone, 1,3-Dimethyl-2-imidazolidinone, N-Dodecyl-2-pyrrolidone, ethyl acetate, benzyl ether, dimethyl sulfoxide, chlorobenzene, dichlorobenzene, 1,2,4-trichlorobenzene, cyclohexanone, benzaldehyde, triethylamine, diethyl ether, tetrahydrofuran, 1,4-dioxane, dimethylformamide; dichloromethane, acetonitrile, chloroform, acetone, N-methylformamide.

In yet other aspects, the solvent comprises 1,3-dioxalane, dimethyl carbonate, dimethoxyethane, benzene, N-methyl-2-pyrrolidone, hexane, ethylene carbonate, propylene carbonate, ionic liquids, or a combination thereof. In yet other aspects, the solvent does not comprise benzyl benzoate, N-Methyl-2-pyrrolidone, 1-Octyl-2-pyrollidone, N-Vinyl-pyrrolidone, 1,3-Dimethyl-2-imidazolidinone, N-Dodecyl-2-pyrrolidone, ethyl acetate, benzyl ether, dimethyl sulfoxide, chlorobenzene, dichlorobenzene, 1,2,4-trichlorobenzene, cyclohexanone, benzaldehyde, triethylamine, diethyl ether, tetrahydrofuran, 1,4-dioxane, dimethylformamide; dichloromethane, acetonitrile, chloroform, acetone, N-methylformamide. In still further aspects, the solvent comprises 1,3-dioxalane, dimethyl carbonate, dimethoxyethane. In still further aspects, the solvent comprises ethylene carbonate, propylene carbonate, or a combination thereof. In still further aspects, the solvent can comprise ionic liquids. In yet other aspects, the solvent does not comprise 1,4-dioxane or tetrahydrofuran.

In further aspects, the solvent used in the solution that does not substantially react with the crystalline electride for a period of time of at least 12 hours, at least 24 hours, at least 48 hours, at least 72 hours, or at least 96 hours.

In some aspects, the crystal structure of the inventive electrides can be characterized based on the diffraction patterns. In exemplary aspects, the diffraction patterns show a hexagonal crystal structure with an interlayer spacing (or a d-spacing) from about 1.5 to about 5.0 Å, including exemplary values of about1.60 Å, about 1.70 Å, about 1.8 Å, about 1.90 Å, about 2.00 Å, about 2.10 Å, about 2.20 Å, about 2.30 Å, about 2.40 Å, about 2.50 Å, about 2.60 Å, about 2.70 Å, about 2.80 Å, about 2.90 Å, about 3.00 Å, about 3.10 Å, about 3.20 Å, about 3.30 Å, about 3.40 Å, about 3.50 Å, about 3.60 Å, about 3.70 Å, about 3.80 Å, about 3.90 Å, about 4.00 Å, about 4.10 Å, about of 4.20 Å, about 4.30 Å, about 4.40 Å, about 4.50 Å, about 4.60 Å, about 4.70 Å, about 4.80 Å, and about 4.90 Å. It is further understood that the interlayer spacing can have any value between two of foregoing values.

In some aspects, the exemplary electrides can have the intra-layer spacing of 1.80±0.01 Å, which matches the simulated d-spacing (1.80 Å) for the {1, 1, 0} family of planes. In yet other aspects, the inventive electrides can have a second set of hexagonal diffraction spots with a larger interlayer spacing (d-spacing) of 3.12±0.02 Å that is not present in the simulated patterns of bulk Ca₂N. In the aspects, where the crystals with a larger interlayer spacing are present, Ca₂N structures can have broken unit cell's symmetry in the z-direction. In some exemplary aspects, the larger interlayer spacing can be observed in simulated diffraction patterns for monolayer and bilayer structures (FIGS. 2(c) and (e)) as well as structures with translational disorder (FIG. 2(d)).

Without wishing to be bound by theory, it is believed that the presence of translational disorder is turbostratic disorder either present in the 3D parent crystal or introduced by a preparation method. In certain aspects, the inventive electride has a crystal 2 D hexagonal structure with lattice parameters matching the bulk crystal and that there is aperiodicity in the z-direction.

In some aspects, the stoichiometry of the 3D crystal can be as Ca₂N 1.00±0.01 and of the inventive 2D material can be as Ca₂N 0.99±0.01 with the error reported as twice the standard deviation. In certain aspects, a two-sample t-test with a significance level of 0.05 suggests that the compositions of the 3D and 2D material are not different; however, a one-sample t-test with a significance level of 0.05 suggests that the stoichiometry of the 2D material can be nitrogen-deficient or calcium-rich compared to the expected ratio of Ca₂N. Without wishing to be bound by theory, it is believed that these exemplary aspects can be explained by a small amount of oxidation on the surface of the 2D material that resulted in the loss of nitrogen as ammonia gas during the preparation or subsequent handling. It is further understood stoichiometric ratios mentioned above are shown for the exemplary Ca₂N electrides. Other electrides can have a stoichiometric ratio similar to Ca₂N or different from Ca₂N; for example, the formula can be M×V, wherein M is a metal, wherein V is a column element (e.g., N), and wherein x is 1.8-2.2.

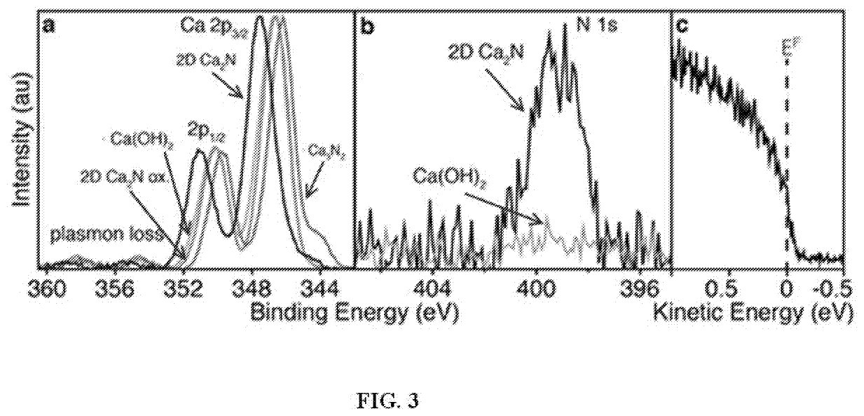

FIG. 3 shows exemplary X-ray photoelectron spectroscopy (XPS) spectra of the surface of the inventive Ca₂N. The calcium 2p core electron spectra (FIG. 3(a), Table 1) of 2D Ca₂N have a Ca 2p doublet with a spin-orbit splitting of 3.5 eV. The Ca 2p3/2 peak is centered at 347.5±0.2 eV (Table 1) with a full-width-half-max (FWHM) of 1.9 eV. In addition, the Ca 2p spectra show plasmon loss peaks shifted by 7.9 and 11.4 eV relative to the Ca 2p3/2 center. These values are in agreement with 3D Ca₂N (Table 1). In certain aspects, after the measurement, the 2D Ca₂N samples can be exposed to ambient conditions. In these aspects, a potential oxidation can happen resulting in a color change from black to white. FIG. 3(a) shows exemplary spectra of the deliberately oxidized samples that match that of Ca(OH)₂ (Table 1).

FIG. 3(b) shows additional exemplary XPS spectra, specifically spectra attributed to the nitrogen 1 s core electron binding energy. In these aspects, the peak, centered at 399.2±0.1 eV with a FWHM of 2.2 eV, is attributed to the N 1 s core electrons in 2D Ca₂N, in agreement with a 3D Ca₂N (399.3±0.1 eV).

TABLE 1
XPS binding energies (eV) of Ca 2p electrons from Ca₂N.

| Material | 2p_{3/2} | 2p_{1/2} | Plasm. A | Plasm.B |
|---|---|---|---|---|
| 2D Ca₂N | 347.5 | 351.0 | 355.4 | 358.9 |
| 3D Ca₂N | 347.5 | 351.0 | 355.5 | 359.0 |
| Ca₃N₂ | 346.2 | 349.7 | 354.3 | 358.0 |
| Ca(OH)₂ | 346.7 | 350.3 | 354.8 | 358.3 |
| 2D Ca₂Nₒₓ | 346.6 | 350.2 | 354.7 | 358.3 |

FIG. 3(c) depicts exemplary ultraviolet photoelectron spectroscopy (UPS) spectra of the inventive 2D flakes. In these exemplary aspects, the density of states at the Fermi energy, EF, (FIG. 3(c)) demonstrates that the electronic structure of our 2D Ca₂N is metallic.

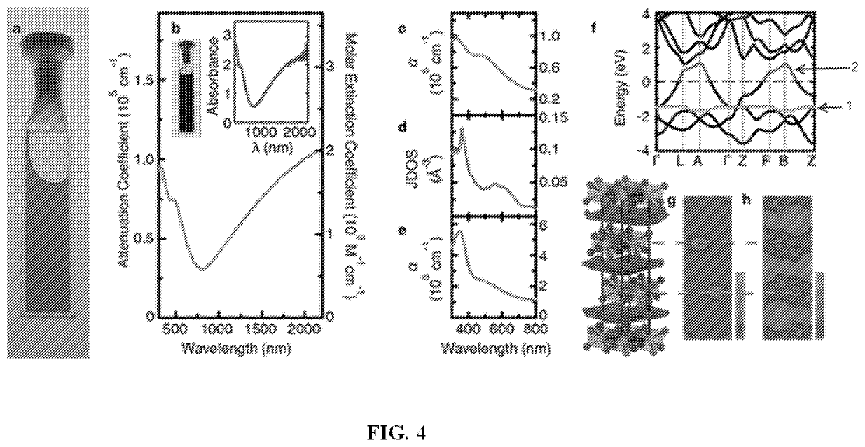

In certain aspects, the electronic structure of the inventive electrides can be further understood by measuring of optical response. In exemplary aspects, the electronic structure of the inventive 2D Ca₂N solutions can be evaluated by measuring the optical response of the inventive 2D flakes dissolved in the solvent with UV-visible-near IR (λ=280-2200 nm) transmission spectroscopy. FIG. 4(a) depicts spectra of 2D Ca₂N flakes dissolved in 1,3-dioxolane. In these exemplary aspects, the solution was light brown in color and transparent (FIG. 4(a)), with an optical extinction that depended linearly on sample concentration. The estimated attenuation coefficient and molar extinction coefficient are shown in FIG. 4(b). Concentrated solutions (1.05 mg/mL) appear opaque (inset FIG. 4(b)) and transmit less than 1% of light at certain wavelengths.

FIG. 4(c) shows UV-visible-near IR spectra of 2D Ca2N suspensions with absorbance peaks at 330 and 480 nm. Without wishing to be bound by theory, in order to understand the origin of these peaks, the measurements were compared to both to the calculated joint density of states (JDOS), (OptaDOS code was used as described in details in the Examples) and to previously reported in the art (Lee, K.; Kim, S. W.; Toda, Y.; Matsuishi, S.; Hosono, H. Nature 2013, 494, 336) experimental data on 3D Ca₂N. In these exemplary aspects, the JDOS shown in FIG. 4(d) (see Examples for details), has local maxima at wavelengths of 360 and 560 nm, in agreement the experimental results shown for the inventive electrides. Additionally a previously reported (Lee, K.; Kim, S. W.; Toda, Y.; Matsuishi, S.; Hosono, H. Nature 2013, 494, 336.) Drude-Lorentz fit of a reflectivity spectrum for 3D Ca₂N was extended to calculate the attenuation coefficient of the 3D material (FIG. 4(e), see Examples for details). In these aspects, the calculated 3D material has local maxima at 360 nm and 520 nm, which is also in agreement with the JDOS and the experimental data measured for the inventive 2D Ca₂N. Therefore, without wishing to be bound by theory, based on these results, the peaks in the UV-vis spectra of 2D Ca₂N were assigned to interband transitions.

In certain aspects, the electrides described here show a transmittance greater than about 10% to about 100%, including exemplary values of about 20%, about 30%, about 40%, about 50%, about 60%, about 70%, about 80%, about 85%, about 90%, about 91%, about 92%, about 93%, about 94%, about 95%, about 96%, about 97%, about 98%, and about 99%. In still further aspects, the transmittance is from about 90% to about 100%. It is understood that the transmittance can be any value between any two foregoing values. In yet other aspects, the transmittance is at least 97%. In still further aspects, the transmittance is 97%.

In some aspects, the nature of the interband transitions can be further investigated by examining the calculated band structure of 2D Ca₂N (FIG. 4(f). Projections of the electron density integrated over states with energies −1.50 to −1.72 eV (marked 1 in FIG. 4(f) show that the electron density resides in the N p orbitals (FIG. 4(g)). Projections of the electron density integrated over states with energies 0 to +1.00 eV (marked 2 in FIG. 4(f)) show that when these states are populated, the electron density occupies the interlayer gap (FIG. 4(h)). Interestingly, direct transitions from the flat band (1) to the on gas, which could impact the material's work function and electrical conductivity under high intensity illumination.

FIG. 4(b) shows the near IR data that demonstrates a response at wavelengths longer than 800 nm. To qualitatively understand whether the long-wavelength response is dominated by scattering or absorbance, the transmittance with the cuvette inside or outside an integrating sphere (see Examples for details). The difference between the spectra, which should be due primarily to light scattering, does not have the same wavelength-dependence as the long-wavelength signal itself. In addition, the attenuation for the two geometries differs by only 20%. Without being bound by theory it was hypothesized that that the near IR response is largely due to the absorbance of light and not scattering. The long-wavelength response is most likely the result of an intraband absorbance of the 2D electron gas.

In certain aspects, the inventive electrides described herein have a high electrical conductivity from about 100 S/cm to about 1×10⁷ S/cm, including exemplary values of about 500 S/cm, about 1×10³ S/cm, about 2×10³ S/cm, about 3×10³ S/cm, about 4×10³ S/cm, about 5×10³ S/cm, about 6×10³ S/cm, about 7×10³ S/cm, about 8×10³ S/cm, about 9×10³ S/cm, about 1×10⁴ S/cm, about 2×10⁴ S/cm, about 3×10⁴ S/cm, about 4×10⁴ S/cm, about 5×10⁴ S/cm, about 6×10⁴ S/cm, about 7×10⁴ S/cm, about 8×10⁴ S/cm, about 9×10⁴ S/cm, about 1×10⁵ S/cm, about 2×10⁵ S/cm, about 3×10⁵ S/cm, about 4×10⁵ S/cm, about 5×10⁵ S/cm, about 6×10⁵ S/cm, about 7×10⁵ S/cm, about 8×10⁵ S/cm, about 9×10⁵ S/cm, about 1×10⁶ S/cm, about 2×10⁶ S/cm, about 3×10⁶ S/cm, about 4×10⁶ S/cm, about 5×10⁶ S/cm, about 6×10⁶ S/cm, about 7×10⁶ S/cm, about 8×10⁶ S/cm, and about 9×10⁶ S/cm. It is further understood that the electrical conductivity can have any value between any two foregoing values.

In yet other aspects, the inventive electrides exhibit a low work function from about 2 to about 4 eV, including exemplary values of about 2.1 eV, about 2.2 eV, about 2.3 eV, about 2.4 eV, about 2.5 eV, about 2.6 eV, about 2.7 eV, about 2.8 eV, about 2.9 eV, about 3.0 eV, about 3.1 eV, about 3.2 eV, about 3.3 eV, about 3.4 eV, about 3.5 eV, about 3.6 eV, about 3.7 eV, about 3.8 eV, and about 3.9 eV.

In still further aspects, the inventive electrides exhibit a sheet resistance from about 1 to about 10 Ohm/sq, including exemplary values of about 2 Ohm/sq, about 3 Ohm/sq, about 4 Ohm/sq, about 5 Ohm/sq, about 6 Ohm/sq, about 7 Ohm/sq, about 8 Ohm/sq, and about 9 Ohm/sq.

In yet other aspects, the inventive electrides exhibit a binding energy between the various layers from greater than 0 J/m² to about 3.0 J/m², including exemplary values of about 0.2 J/m², about 0.5 J/m², about 0.8 J/m², about 1.0 J/m², about 1.2 J/m², about 1.5 J/m², about 1.8 J/m² , about 2.0 J/m², about 2.2 J/m², about 2.5 J/m², and about 2.8 J/m². It is understood that the binding energy of the inventive electrides can have any value between any two foregoing values.

Further discloses herein are articles comprising the disclosed electrides. In some aspects, the article is a catalyst. In other aspects, the article is a component of a catalyst. In still further aspects, the article can be a reagent. In these aspects, the exemplary reagent can be a reducing agent.

In some aspects, the articles can comprise an energy storage device, an optoelectronic device, a magnetic device or any combination thereof. In still further aspects the articles can comprise a flat panel display, a touch screen panel, a solar cell, a battery, an e-window, an electrochromic mirror, a heat mirror, a transparent transistor, a flexible display, a transparent conductive electrode, a catalyst or any combination thereof.

### Methods

Disclosed herein are methods of making disclosed electrides. Disclosed herein is a method comprising (a) contacting a compound represented by a formula A₂N, wherein A comprises Mg, Sr, Ba, Ca, or a combination thereof, with a solvent that does not substantially react with the solvent for a period of time of at least 48 hours; and (b) exfoliating a crystalline electride comprising at least one positively charged layer comprising at least one alkaline earth metal subnitride represented by a formula A₂N, wherein A comprises Mg, Sr, Ba, Ca, or a combination thereof, and one or more layers of anionic electrons.

In certain aspects, the compound represented by a formula A₂N used in step (a) has a 3D structure. In yet other aspects, the compound represented by a formula A₂N used in step (a) has a 2D structure. In still further aspects, the crystalline electride comprising at least one positively charged layer comprising at least one alkaline earth metal subnitride represented by a formula A₂N in step (b) has a 2D structure.

It is understood that to peel apart layers of a van der Waals crystal, only van der Waals interactions have to be overcome; however, to exfoliate a layered electride, electrostatic interactions also have to be overcome. The methods of current invention disclose exfoliation of the inventive electrides. As previously shown, the binding energy between the various layers as a function of interlayer distance in the inventive electrides is from greater than 0 J/m² to about 3.0 J/m². In exemplary aspects, it was found based on calculation that the binding energy between Ca₂N layers is about 1.11 J/m². In these exemplary aspects, the binding energy of Ca₂N is only about four times that of graphite (0.31 J/m²). Electrostatic interactions between the [Ca₂N]⁺ and electron gas likely account for the greater binding energy of Ca₂N compared to graphite, a van der Waals solid.

Previously used Scotch-tape methods to exfoliate layered van der Waals solids may not be appropriate for inventive electrides, for example, Ca₂N. The electrides, such as Ca₂N are chemically reactive and can decompose in contact with many adhesives. For such a reactive material, the conditions of liquid exfoliation are more suitable because the solvent's functional groups can be chosen to avoid reaction. Liquid exfoliation offers additional advantages such as a much higher yield, scalability, facile material transfer, and easy thin-film preparation.

In some aspects, the compound disclosed in step (a) of the inventive method was contacted with a solvent to determine the solvent reactivity towards the compound. In other aspects, the solvents used for the exfoliation can be any solvents disclosed herein. In certain aspects, the solvents can be any solvents known in the art.

In certain aspects, the solvents can comprise 1,3-dioxolane, dimethyl carbonate, dimethoxy ethane, toluene, hexane, benzene, benzyl benzoate, N-Methyl-2-pyrrolidone, ethylene carbonate, propylene carbonate, ionic liquids, 1-Octyl-2-pyrollidone, N-Vinyl-pyrrolidone, 1,3-Dimethyl-2-imidazolidinone, N-Dodecyl-2-pyrrolidone, ethyl acetate, benzyl ether, dimethyl sulfoxide, chlorobenzene, dichlorobenzene, 1,2,4-trichlorobenzene, cyclohexanone, benzaldehyde, triethylamine, diethyl ether, tetrahydrofuran, 1, 4-dioxane, dimethylformamide; dichloromethane, acetonitrile, chloroform, acetone, N-methylformamide.

In yet other aspects, the solvent comprises 1,3-dioxalane, dimethyl carbonate, dimethoxyethane, benzene, N-methyl-2-pyrrolidone, hexane, ethylene carbonate, propylene carbonate, ionic liquids, or a combination thereof. In yet other aspects, the solvent does not comprise benzyl benzoate, N-Methyl-2-pyrrolidone, 1-Octyl-2-pyrollidone, N-Vinyl-pyrrolidone, 1,3-Dimethyl-2-imidazolidinone, N-Dodecyl-2-pyrrolidone, ethyl acetate, benzyl ether, dimethyl sulfoxide, chlorobenzene, dichlorobenzene, 1,2,4-trichlorobenzene, cyclohexanone, benzaldehyde, triethylamine, diethyl ether, tetrahydrofuran, 1,4-dioxane, dimethylformamide; dichloromethane, acetonitrile, chloroform, acetone, N-methylformamide. In still further aspects, the solvent comprises 1,3-dioxalane, dimethyl carbonate, dimethoxyethane. In yet other aspects, the solvent comprises ethylene carbonate, propylene carbonate, or a combination thereof. In still further aspects, the solvent can comprise ionic liquids. In yet other aspects, the solvent does not comprise 1,4-dioxane or tetrahydrofuran.

In certain aspects, the liquid exfoliation can be assisted by mechanical agitation such as sonication, shearing, or ball milling.

In other aspects, the contact with the solvent and the liquid exfoliation is done under anhydrous and oxygen-free conditions. In yet other aspects, the compound of the step (a) and the solvent can be sonicated. In certain aspects, the sonication is done for about 5 min to about 600 min, including exemplary values of about 10 min, about 20 min, about 30 min, about 40 min, about 50 min, about 60 min, about 70 min, about 80 min, about 90 min, about 100 min, about 120 min, about 140 min, about 160 min, about 180 min, about 200 min, about 220 min, about 240 min, about 260 min, about 280 min, about 300 min, about 320 min, about 340 min, about 360 min, about 380 min, about 400 min, about 420 min, about 440 min, about 460 min, about 480 min, about 500 min, about 520 min, about 540 min, about 560 min, and about 580 min. In still further aspects the sonication can be performed up to about 100 hours, but it is not limited to thereto. In yet other aspects, the sonication can be done in a water sonicator. In still further aspects the ultrasonication can be utilized.

In certain aspects, an additive such as a surfactant may be added to the solvent in order to facilitate the exfoliation and limit (and/or prevent) the exfoliated nanosheets from being agglomerated. In some exemplary aspects, the surfactants can include, but are not limited to, sodium dodecyl sulfate (SDS) and sodium dodecyl benzenesulfonate (SDBS).

In still further aspects, the concentration of compound (a) in the solvent can be greater than or equal to about 0.001 g/ml, for example, within a range from about 0.001 g/ml to about 10 g/ml, but is not limited thereto. In still further aspects, the concentration of compound (a) in the solvent can be greater than or equal to about 0.01 g/ml, about 0.05 f/ml, 0.01 g/ml, about 0.05 g/ml, about 0.1 g/ml, about 0.5 g/ml, about 1 g/ml, about 2 g/ml, about 3 g/ml, about 4 g/ml, about 5 g/ml, about 6 g/ml, about 7 g/ml, about 8 g/ml, about 9 g/ml, or about 10 g/ml.

In some aspects, the reactivity of the solvent can be identified by eye. In certain aspects, protic solvents like isopropyl alcohol and N-methylformamide react vigorously with Ca₂N to form Ca(OH)₂. In other exemplary aspects, in the solvents, such as, chloroalkanes, ketones, aldehydes, nitriles, and even some ethers, the dark blue Ca₂N powder decomposed to a white powder in less than 24 hours. In still further aspects, the non-polar hydrocarbons including benzene and hexanes do not react with Ca₂N, however they also do not allow an effective exfoliation. In these aspects, the dispersions can be precipitated within minutes. Without wishing to be bound by theory, it is believed that, while non-polar hydrocarbons may not be appropriate for liquid exfoliation, they could be used to protect Ca₂N from air or water environments.

In the aspects, wherein aprotic amides like N-methyl-2-pyrrolidone are used, the exfoliation showed only modest stability: the materials precipitated rapidly and partially oxidized to Ca(OH)₂ over a period of 5 to 10 days.

In yet other aspects, the methods disclosed herein comprise a step of separating the crystalline electride form the solvent. The separation step can comprise any steps known in the art. In some exemplary aspects, the separation comprises decantation, or evaporation.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1

First, 3D Ca₂N was synthesized by the reduction of Ca₃N₂ (Alfa Aesar, 99%) with Ca metal (Alfa Aesar, redistilled granules ˜16 mesh, 99.5%) as adapted from previous literature, such as Lee, K.; Kim, S. W.; Toda, Y.; Matsuishi, S.; Hosono, H. Nature 2013, 494, 336, and Reckeweg, O.; DiSalvo, F. J. Solid State Sci. 2002, 4, 575.

The Ca₃N₂ was then ground into a very fine powder and Ca granules were added. The mixture, then, was ground lightly together in a 1.02:1 Ca:Ca₃N₂ molar ratio (total mass of a typical batch: 1.2 g) and pressed into a pellet under ˜0.56 GPa of pressure using a hydraulic press. The pellet, along with an additional ˜0.600 g of Ca metal, was placed into a pocket of Mo foil (Alfa Aesar 99.95%), which was subsequently crimped closed. The Mo pocket was then sealed inside an evacuated (4×10⁻³ mbar) quartz ampoule (18 mm ID, ˜6-7 cm in length). The ampoule was heated in a Lindberg Blue tube furnace to 1100 K at a ramp rate of 100K/hr. The temperature was held at 1100 K for 2 days and cooled to room temperature over 24 hours. The additional calcium metal that was added inside of the Mo pocket reacted with the quartz ampoule covering the ampoule wall in shiny black/grey material. It was demonstrated that adding additional Ca helps prevent the loss of Ca from the pellet. The obtained Ca₂N pellet was black. When broken apart, the material was black and shiny with a blue luster. All materials were stored in a glovebox with a nitrogen atmosphere (oxygen <0.01 ppm) and all synthetic steps were carried out under nitrogen atmosphere.

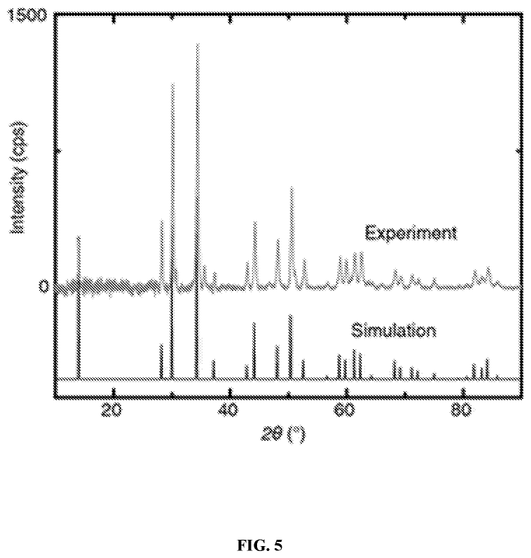

To measure an X-ray diffraction pattern of Ca₂N (FIG. 5), the powder was ground very finely, deposited on a roughened glass slide, and covered with 1 mil Kapton tape while in the glovebox to prevent oxidation during the measurement. The measurement was taken using a Rigaku Multiflex X-ray diffractometer with a CuKα X-ray source. The synthesized crystal was compared to data reported in Gregory, D. H.; Bowman, A.; Baker, C. F.; Weston, D. P. J. Mater. Chem. 2000, 10, 1635. It was found that the date characterizing the synthesized crystal are in agreement with the reported hexagonal crystal system, R3̅m space group, and lattice parameters a=3.624 c=19.100 Å. The Kapton tape has a broad signal from 10-26°, which reduces the relative intensity of the 003 peak and increases the noise in that region.

### Example 2

Density functional theory (DFT) calculations were performed using the CASTEP code (published in Clark, S. J.; Segall, M. D.; Pickard, C. J.; Hasnip, P. J.; Probert, M. I.; Refson, K.; Payne, M. C. Z. Kristallogr. 2005, 220, 567) with plane-wave basis set approximations as provided in Kresse, G.; Furthmüller, J. Phys. Rev. B 1996, 54, 11169. Ultrasoft pseudopotentials described in Vanderbilt, D. Phys. Rev. B 1990, 41, 7892 were used to describe core electrons, and a 400 eV cut-off energy was used. It was demonstrated that for this cut-off energy, calculations were convergent with dE/dE_{cut} less than 0.01 meV/atom. A GGA PBE functional as described in Perdew, J. P.; Yue, W. Phys. Rev. B 1986, 33, 8800 was used for the exchange-correlation contribution to total energy and Grimme's DFT-D correction described in Grimme, S. J. Comput. Chem. 2006, 27, 1787 was used to account for long-range dispersion forces. Both graphite and bulk Ca₂N were structurally relaxed prior to further calculations. A Monkhorst-Pack grid, described in Monkhorst, H. J.; Pack, J. D. Phys. Rev. B 1976, 13, 5188, of 8×8×2 k-points was used for the geometry optimization and interlayer binding energy study. Each crystal structure relaxed to within 2% of experimentally determined parameters.

To determine binding energy for both graphite and Ca₂N, the interlayer distance between layers in each crystal structure was varied and the total energy then calculated. An “infinite” structure was built with an interlayer distance of 12 Å, such that there were no interactions between sheets. The interlayer binding energy as either (E-E_{∞})/(# of atoms at interface) or (E-E_{∞})/(# of interfaces×area) was then calculated.

For electronic structure calculations, a denser MK grid, of 64×64×10 and 64×64×64 for the hexagonal and rhombedral orientations of Ca₂N was used. The integrated electron density was found to be within 0.0001 e⁻ of the total electron count, and thus it was assumed that all electrons were accounted for and the used mesh was sufficient to accurately describe electron density.

The joint density of states (JDOS) was calculated from the CASTEP output with OptaDOS code (as described in Morris, A. J.; Nicholls, R.; Pickard, C. J.; Yates, J. Comp. Phys. Comm. 2014, 5, 1477; Pickard, C. J.; Payne, M. C. Phys. Rev. B, 1999, 7, 4685; and Pickard, C. J.; Payne, M. C. Phys. Rev. B, 2000, 7, 4383) using a Gaussian broadening scheme with a 0.05 eV smearing width. To image the orbital projections of valence and conduction band states, the STM profile module of CASTEP was used for a given negative or positive bias, respectively. Specifically, an applied bias of −1.49 eV was used to image the interlayer electron gas of bulk Ca₂N. To obtain the electron density profile, Perl scripting was used to extract and integrate total electron count across the z-axis of the hexagonal unit cell.

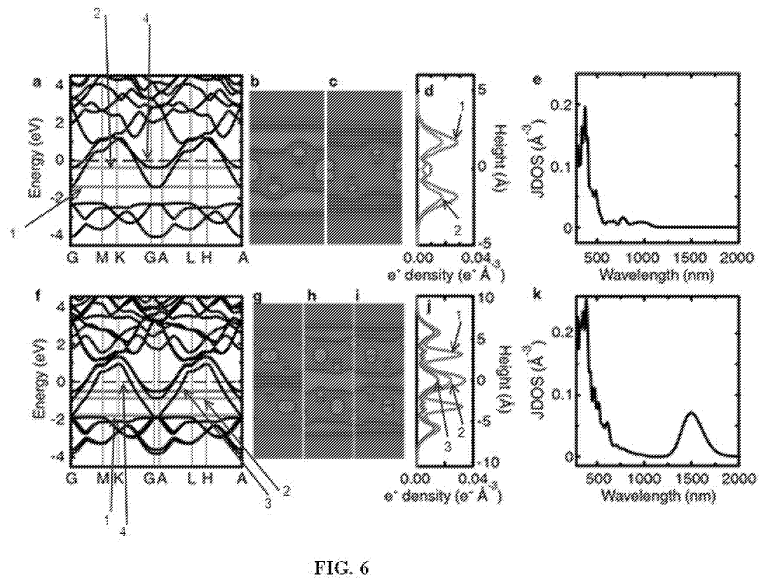

It was shown that the band structure of Ca₂N changes subtly with thickness (FIGS. 6(a) and (f)) and does not change with lateral interlayer translation. Therefore, it was expected that the band structure of inventive few-layer flakes to be similar to that of the 3D solid.

Images of the orbital projections for monolayer Ca₂N show that both of the bands that cross the Fermi level contribute to the electron density covering the monolayer's surface (FIGS. 6(b), (c), and (d). It was found that the electron gas extends as far as 2.0 Å from the calcium atoms of the monolayer. Images of the orbital projections for bilayer Ca₂N show that the electron gas sandwiched between layers is at a slightly lower energy than the electron gas at the surface (FIGS. 6(g) and (j)) and that the electron gas at the surface consists largely of filled states in the energy range −0.56 eV to E_{F} (FIGS. 6(i) and (j)).

The JDOS for the bilayer showed a distinct peak at 1,500 nm (FIG. 6). Without wishing to be bound by theory it is believed that this peak arises from direct transitions from the lowest of the three bands crossing the Fermi level to either of the top two bands crossing the Fermi level. It was found that the top two bands are primarily composed of states in which the electron density resides on the outer-most electron layer, while the lowest of the three bands is composed of states in which the electron density is sandwiched in between planes of [Ca₂N]⁺.

### Example 3

Various solvents have been investigated to determine an appropriate solvent system for an efficient exfoliation of the inventive electrides. All solvents were purchased from Sigma Aldrich and dried with 4 Å molecular sieves unless otherwise noted. The solvents included: 1,3-dioxolane (anhydrous, 99.5%), dimethyl carbonate (anhydrous, ≥99%), dimethoxy ethane (anhydrous, 99.5%), toluene (Fisher 99.9%), hexane (Fisher 99.9%), benzene (≥99.9%), benzyl benzoate (≥99.0%), ethyl acetate (Fisher, 99.9%), N-methyl-2-pyrrolidone (anhydrous, 99.5%), 1-vinyl-2-pyrrolidinone (≥99%), 1-octyl-2-pyrrolidone (≥98%), 1,3-dimethyl-2-imidazolidinone (≥99%), N-dodecyl-2-pyrrolidinone (≥99%), benzyl ether (≥98%), dimethylsulfoxide (≥99.9%), chlorobenzene (≥99.5%), dichlorobenzene (≥99.5%), 1,2,4-trichlorobenzene (≥99.5%), cyclohexanone (≥99.8%), benzaldehyde (≥99%), triethylamine (≥99%), diethyl ether (Fisher, 99.9%), tetrahydrofuran (anhydrous, 99.8%), 1,4-dioxane (anhydrous, 99.8%), dimethylformamide (≥99%), dichloromethane (Fisher, 99.9%), acetonitrile (Acros, anhydrous, 99.9%), acetone (Fisher, 99.9%), and N-methylformamide (≥99%).

A bulk Ca₂N powder (10 mg) was suspended in each solvent (20 mL) (in a glovebox). The suspensions in polypropylene-capped vials were sealed with additional parafilm and Teflon tape wrapped around the lid. The sealed suspensions were sonicated for 100 minutes in a water sonication bath outside of the glovebox with the temperature of the bath below 34° C.

The results of liquid exfoliation in various solvents are shown in Table 2. Ca₂N in compatible solvents remained black after several days and remained suspended. Ca₂N in non-reactive solvents remained black after several days and precipitated rapidly. Ca₂N in slightly reactive solvents decomposed to a white powder after 5-10 days. Ca₂N in reactive solvents decomposed to a white powder after 24-72 hours. Ca₂N in very reactive solvents decomposed to a white powder and produced bubbles within minutes.

TABLE 2.
Liquid Exfoliation of Ca₂N.

| Solvent | Comments |
|---|---|
| 1,3- dioxalane | Compatible for Ca₂N exfoliation |
| Dimethyl carbonate | Compatible for Ca₂N exfoliation |
| Dimethoxy ethane | Compatible for Ca₂N exfoliation |
| Toluene | Non-reactive |
| Hexane | Non-reactive |
| Benzene | Non-reactive |
| Benzyl Benzoate | Slightly Reactive (Ca₂N is decomposed after |
| | 5-10 days) |
| N-Methyl-2-pyrrolidone | Slightly Reactive (Ca₂N is decomposed after |
| | 5-10 days) |
| 1-Octyl-2-pyrrolidone | Slightly Reactive (Ca₂N is decomposed after |
| | 5-10 days) |
| N-Vinylpyrrolidone | Reactive (Ca₂N is decomposed after 24-72 |
| | hours) |
| 1,3-Dimethyl-2- | Reactive (Ca₂N is decomposed after 24-72 |
| imidazolidinone | hours) |
| N-Dodecyl-2-pyrrolidone | Reactive (Ca₂N is decomposed after 24-72 |
| | hours) |
| Ethyl acetate | Reactive (Ca₂N is decomposed after 24-72 |
| | hours) |
| Benzyl ether | Reactive (Ca₂N is decomposed after 24-72 |
| | hours) |
| Dimethyl sulfoxide | Reactive (Ca₂N is decomposed after 24-72 |
| | hours) |
| Chlorobenzene | Reactive (Ca₂N is decomposed after 24-72 |
| | hours) |
| Dichlorobenzene | Reactive (Ca₂N is decomposed after 24-72 |
| | hours) |
| 1,2,4-trichlorobenzene | Reactive (Ca₂N is decomposed after 24-72 |
| | hours) |
| Cyclohexanone | Reactive (Ca₂N is decomposed after 24-72 |
| | hours) |
| Benzaldehyde | Reactive (Ca₂N is decomposed after 24-72 |
| | hours) |
| Triethylamine | Reactive (Ca₂N is decomposed after 24-72 |
| | hours) |
| Diethyl ether | Reactive (Ca₂N is decomposed after 24-72 |
| | hours) |
| Tetrahydrofuran | Reactive (Ca₂N is decomposed after 24-72 |
| | hours) |
| 1,4-dioxane | Reactive (Ca₂N is decomposed after 24-72 |
| | hours) |
| Dimethylformamide | Reactive (Ca₂N is decomposed after 24-72 |
| | hours) |
| Dichloromethane | Reactive (Ca₂N is decomposed after 24-72 |
| | hours) |
| Acetonitrile | Reactive (Ca₂N is decomposed after 24-72 |
| | hours) |
| Chloroform | Reactive (Ca₂N is decomposed after 24-72 |
| | hours) |
| Acetone | Very reactive (Ca₂N is decomposed within |
| | minutes) |
| N-Methylformamide | (Ca₂N is decomposed within minutes) |

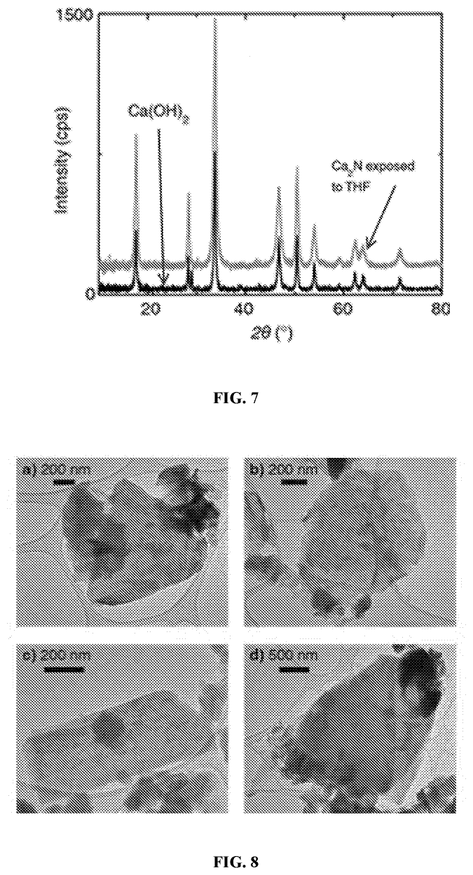

While it was found that a successful liquid exfoliation can be down in 1,3-dioxolane, solvents having a similar structure, such as 1,3-dioxolane, tetrahydrofuran (THF), and 1,4-dioxane failed to provide an exfoliated flakes. It was shown that Ca₂N (10 mg) decomposed to a white powder after 24-72 hours of exposure to THF or 1,4-dioxane. To ensure that the solvents had very minimal water content and to remove stabilizers, each solvent was dried over sodium metal and distilled over a Schlenk line with N₂ environment. The repeated screening yielded the same results; Ca₂N (10 mg) decomposed to a white powder after 24-72 hours of exposure to THF or 1,4-dioxane. It was demonstrated that the X-ray diffraction pattern of the white powder matches that of Ca(OH)₂ (FIG. 7).

In all subsequent experiments, where 1,3-dioxolane was used as exfoliating solvent, it was additionally dried over sodium and distilled just before use.

### Example 4

Ca₂N powder was suspended in 1,3-dioxolane (2.5 mg/mL) as described above and was sonicated for 800 minutes under anhydrous and oxygen-free conditions. The suspension was centrifuged at 300 rpm for 15 min to isolate the exfoliated material. Several microliters of the suspension were drop-cast onto a lacey carbon grid and dried in a vacuum chamber for 30 minutes. The samples were loaded into a high-resolution transmission electron microscope (HR-TEM) using a nitrogen-filled glovebox to minimize exposure to air and water.

To obtain selected area diffraction patterns, the samples were loaded into a low resolution TEM following the same procedure as above. TEM images show that the materials are thin and flat though there is a distribution of flake thicknesses and sizes (FIG. 8). Some material is non-sheet-like or appears to be an aggregate of sheets despite our attempt to isolate the thinnest materials.

To further understand the effect of flake thickness on the diffraction pattern, crystal structures of Ca₂N with thicknesses of 1-8 layers was modeled. The monolayer (FIG. 9(a)) shows two sets of hexagonal diffraction spots with d-spacing 1.80 and 3.12, which is in agreement with the experimental measurements. For flakes thicker than a bilayer, the intensity of the spot corresponding to the larger d-spacing was found to be negligible.

The effect of translational disorder was examined by modeling various stacking configurations of Ca₂N. Without being bound by theory, the material is understood to have an ABC stacking sequence in the three layers in the unit cell, but the energetic cost of translating layers is low. The alternate stacking sequences were modeled, including ABAC, ABAB, ACAC, ABC-ABC-ABA-ABC-ABC, ACC-ACC-ABA-CBB-BAB sequences. For example, in the sequence ABC-ABC-ABA-ABC-ABC the ninth “C” plane has been replaced with an “A” plane, which is equivalent to translating that “C” plane by 2.09 Å in the direction perpendicular to the X-axis. In the translated structures, like the ABC-ABC-ABA-ABC-ABC stacking sequence (FIG. 9(c)), both sets of diffraction spots are present. The intensity of the spots varies significantly with the stacking sequence. For example, in the highly disordered sequence ACC-ACC-ABA-CBB-BAB (FIG. 9(d)), the diffraction spots of the larger d-spacing (3.12 Å) are more intense than the spots at the smaller d-spacing (1.80 Å).

Example 5

The calcium and nitrogen content of metal nitrides was measured. To determine the concentration of calcium, Ca²⁺ was titrated with ethylenediaminetetraacetic acid (EDTA, Sigma Aldrich, 99%) in the presence of the indicator carconcarboxylic acid (Alfa Aesar, used-as-received) as shown in Patton, J.; Reeder, W. 1956, 28, 1026. First, under nitrogen atmosphere, the samples were digested into (NH₄)₂SO₄ and Ca(OH)₂ by injecting 1 M H₂SO₄ (Fischer, Trace Metal Grade). Then the digested samples were diluted in deionized water to a measurable concentration (about 1.5 mM). The pH of the titrand was kept basic by the addition of NaOH (0.583 M final concentration), which was prepared from NaOH pellets (Fischer, NF/FCC) and deionized water. A stock solution of indicator was prepared fresh for each trial by dissolving carconcarboxylic acid (0.168 mM final concentration) in a 50/50 v/v water-isopropyl alcohol mixture, which was added to the titrand. Sodium potassium tartrate (Sigma Aldrich, ≥99%, 0.0202 M final concentration) was also added to the titrand. The solution was titrated with 0.1202 mM EDTA. Each measurement was repeated ten times.

To measure the amount of nitrogen, the Berthelot reaction as described in Searle, P. L. Analyst 1984, 109, 549 was used. As one of ordinary skill in the art would readily appreciate, the Berthelot reaction is a stoichiometric reaction between ammonia and phenol that yields a blue indophenol dye, the concentration of which is quantified by spectroscopy. The samples of metal nitrides were digested into (NH₄)₂SO₄ and Ca(OH)₂ by injecting 1 M H₂SO₄ (Fischer, Trace Metal Grade). Standards (1.860 to 753.2 μM) of (NH₄)₂SO₄ (Alfa Aesar, >99%) with Ca(OH)₂ (Fischer, Certified) in a 1:1 ratio were prepared in deionized water and stored in a refrigerator. To the samples and standards, solutions of EDTA (final concentration 0.003479 M), phenol (Alfa Aesar, 99%, unstabilized, 0.06345 M final concentration), sodium nitroprusside (Alfa Aesar, 99%, 0.09375 mM final concentration), Na₂HPO₄ (Sigma Aldrich, 99.95%, final concentration 0.9099 mM), NaOCl (Sigma Aldrich, reagent grade, available chlorine 4.00-4.99%, final concentration 0.03885 M), and NaOH (Fischer, NF/FCC, final concentration 0.1610 M) were added. The combined solutions were incubated for 50 minutes to develop color. Then the solution was pipetted into a glass cuvette and measured using a Cary 5000 double-beam spectrometer using 450-800 nm wavelength light. The indophenol dye has a λₘₐₓ=640 nm. Each measurement was repeated ten times.

The applicability of this approach to metal nitrides was confirmed by measuring the stoichiometry of Ca₃N₂ (Alfa Aesar, 99%) as Ca₃N_{2.02±0.03}. In addition, both the calcium and nitrogen assays gave molar concentrations that match the expected amount of sample digested. For example, a sample (19.1±1 mg) of Ca₃N₂, which was expected to contain 384±20 μmol of calcium and 256±10 μmol of nitrogen, was measured to contain 384±5 μmol of calcium and 260±4 μmol of nitrogen. Therefore, in addition to an accurate stoichiometry, this method can be used to measure the concentration of unknown masses of metal nitrides, for example measure the concentration of our 2D Ca₂N suspended in 1,3-dioxolane.

### Example 6

X-ray photoemission spectroscopy (XPS) was used to investigate the surface of 2D Ca₂N, 3D Ca₂N, Ca₃N₂, oxidized Ca₂N, and Ca(OH)₂. Suspensions of 2D Ca₂N in 1,3-dioxolane were drop-cast onto a p-doped silicon wafer with a thick thermal oxide (300 nm) under inert atmosphere (N₂, <0.01 ppm O₂, <0.01 ppm H₂O). The wafer was heated to 75° C. for 15 min and subsequently dried under low vacuum for 15 min to drive off 1,3-dioxolane. Ca₃N₂, Ca(OH)₂, and oxidized Ca₂N (exposed to ambient conditions for two weeks) were each imbedded into indium foil under inert atmosphere. The samples were then loaded into a Kratos Axis Ultra Delay-Line Detector (DLD) spectrometer under dry N₂ conditions and held under a high vacuum (<10⁻⁹ torr) for analysis. The oxide species were loaded into the XPS instrument separately from air-sensitive samples. The X-ray source was a monochromatic Al Kα source (1487.7 eV). A charge neutralizer (1.8 A filament current, 2.8 V charge balance, 0.8 V filament bias) was used with all oxide species; air-sensitive species were investigated with and without the charge neutralizer. The spectra were corrected to the carbon 1 s peak for adventitious carbon (284.6 eV).(Miller, D.; Biesinger, M.; McIntyre, N. Surf. Interface Anal. 2002, 33, 299).

The ratio of Ca:N for 2D Ca₂N (5.3:1), Ca₃N₂ (4.6:1), and oxidized Ca₂N (18:1) was measured by comparing the area of the peaks of the Ca 2p core electrons to N 1 s core electrons and accounting for the atomic sensitivity factors. It was found that the ratio is significantly calcium-rich in all measurements and the intensity of the nitrogen peak is low in all samples.

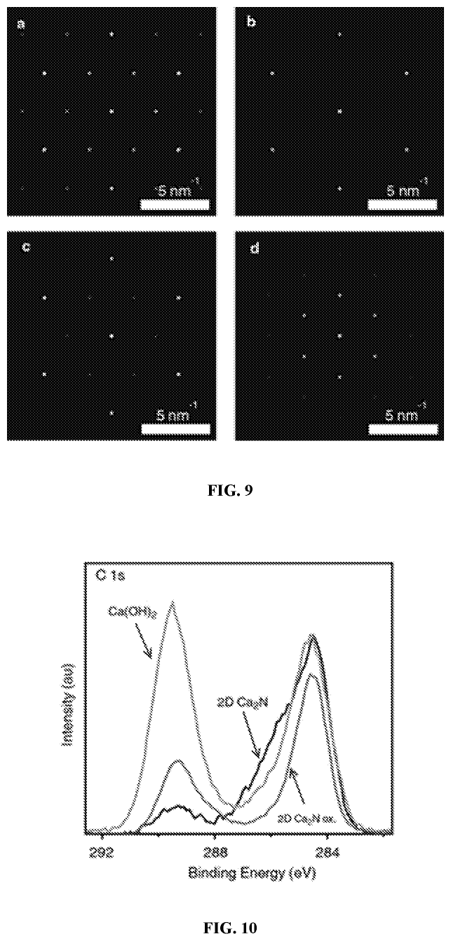

It was noted that in the C 1 s spectra, the area of the peak at ˜289.5 eV increases relative to the area of the peak at 284.6 eV for oxidized 2D Ca₂N relative to unoxidized Ca₂N (FIG. 10). This was observed in all samples and it was speculated that it can be indicative of CaCO₃ or other C|O bond formation.

Ultraviolet photoemission spectroscopy (UPS) was used to provide information about the valence band of the material and the density of states near the Fermi energy edge. For UPS studies, 2D Ca₂N samples were drop-cast onto metal-plated silicon wafers (5 nm adhesive metal, either Cr or Ti, and 50 nm of conductive metal, either Au or Pt). Samples were prepared in the same manner as for XPS analysis described above. A He I source (21.2 eV) was used for UPS measurements.

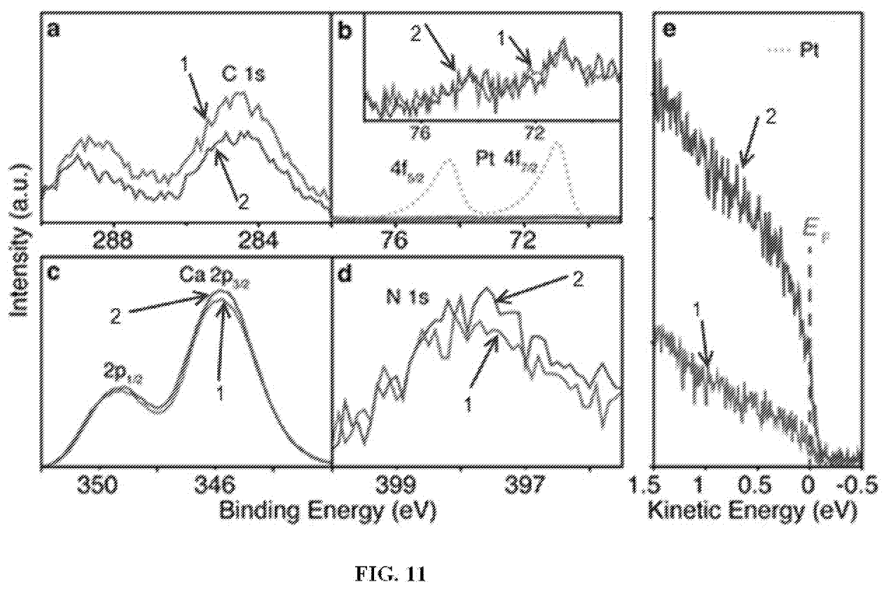

In order to measure the metallic character of Ca₂N and not the substrate, films were cast much thicker than the escape depth of electrons. The films were characterized by XPS and then the surface of the films was cleaned by argon ion sputtering. The quality of substrate coverage by Ca₂N was assessed by measuring the area of peaks from Pt or Au. The sputtering was performed twice for 15 minutes, each time with an accelerating voltage of 1 kV and an emission current of 10 mA. The resulting spectra are shown in the FIG. 11. After sputtering the surface of 2D Ca₂N, XPS was used to determine the relative content of carbon (FIG. 11(a)), platinum (FIG. 11(b)), calcium (FIG. 11(c)), and nitrogen (FIG. 11(d)). It was found that the carbon content decreased as sputtering time increased and that the calcium and nitrogen content increased. Without being bound by theory, it was hypothesized that this results are consistent with the removal of hydrocarbons from the surface of 2D Ca₂N. Furthermore, the unchanged position and shape of the calcium and nitrogen peaks after the sputtering indicated that the material was not changed or damaged during the sputtering process. Additionally, these results also verified that the film is generally thicker than the escape depth of the electrons since peaks from the Pt substrate (FIG. 11(d)) are barely detectable. Furthermore, the density of states up to the Fermi edge (FIG. 11(e)) becomes more prominent as hydrocarbons are removed from the surface of the thick film.

It is understood that, generally, UPS allows for calculation of the work function ϕ of a material. The work function is related to the Fermi energy of the instrument E_{F}, the energy of the incident photon hv, and the lowest kinetic energy at which electrons are emitted, E_{SECO}:

ϕ=hv−(E_{F}−E_{SECO})

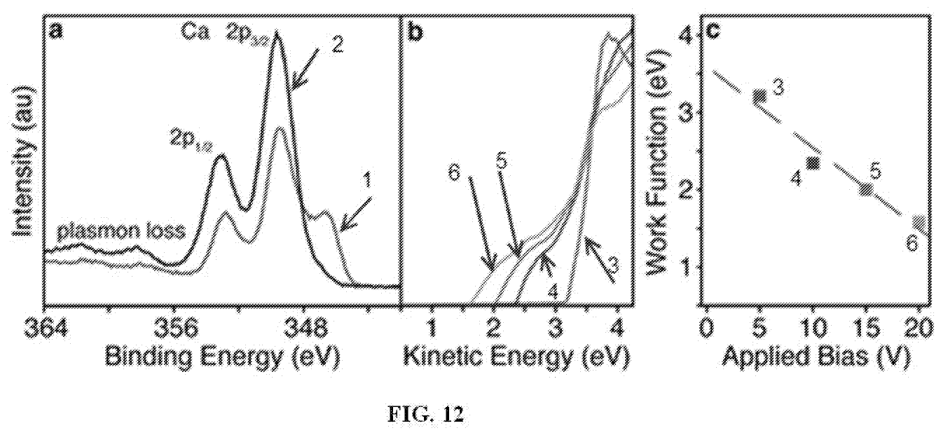

It was found that the surface of Ca₂N experiences a differential charging effect. As shown in FIG. 12(a), the XPS spectra of Ca 2p core electrons with the charge neutralizer active shows an additional feature that is not present in the spectra when the charge neutralizer is off; and thus, demonstrating a differential charging effect. Similarly in UPS, differential charging affects the secondary electrons emitted and prevents an accurate work function from being measured. The secondary cutoff electron edge E_{SECO} of 2D Ca₂N corrected by the applied bias, shown in FIG. 12(b), have a secondary feature that is induced with increasing applied biases. In FIG. 12(c), the work functions extracted from FIG. 12(b) are plotted against the applied bias. The slope of the line (Δ ϕ/Δ bias) varies between samples, but in all cases is much less than 1, which can suggest, without being bound by theory, that the sample exhibits differential charging. Unfortunately, this also indicates that a reliable work function cannot be extracted from the surface of the material because the energy of the secondary electrons is dependent on the applied bias and the degree of differential charging each sample experiences. Other metals (eg. Au, Pt) with known work functions were tested and observe differential charging was not observed in those metals. Therefore, it is believed that the demonstrated response is from the Ca₂N sample and not an artifact of the instrument.

### Example 7

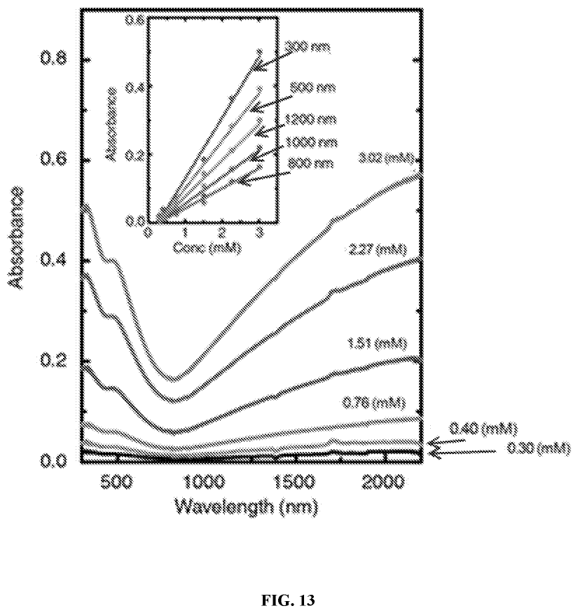

The optical response of 2D Ca₂N was measured with UV-visible-near IR (λ=280-2200 nm) transmission spectroscopy using a Cary 5000 double-beam spectrometer with an external integrating sphere attachment. Quartz cuvettes (Starna 1 mm path length) were filled with suspensions of 2D Ca₂N in 1,3-dioxolane in a glovebox and sealed with parafilm to maintain the N₂ atmosphere during the measurement. The attenuation of light through the sample depended linearly on sample concentration across all measured wavelengths (FIG. 13).

Previously reported in Lee, K.; Kim, S. W.; Toda, Y.; Matsuishi, S.; Hosono, H. Nature 2013, 494, 336 reflectivity data for 3D Ca₂N yielded a fit to the Drude-Lorentz model, which resolved one Drude component, described by a plasma frequency, ωₚ, of 2.78 eV and mean scattering time, τ, of 0.64 ps, and two Lorentz components at 2.39 and 3.37 eV.

$${ω}_{p}^{2} = \frac{N {e}^{2}}{{m}_{o} {ϵ}_{o}} \qquad ( 1 )$$

The Drude susceptibility, χ_{D}, described by ωₚ and a damping factor

$$γ = \frac{1}{τ}$$

(Equation 2), primarily accounts for intra-band absorbance of free-carriers.

$${χ}_{D} ( ω ) = \frac{- {ω}_{p}^{2}}{( {ω}^{2} + i γ ω )} \qquad ( 2 )$$

The Lorentz contribution χ_{Lj}, described by an oscillator frequency ωⱼ and damping factor γ (Equation 3), accounts for inter-band transitions.

$${χ}_{Lj} ( ω ) = \frac{{ω}_{p}^{2}}{( {ω}_{j}^{2} - {ω}^{2} - i γ ω )} \qquad ( 3 )$$

The fit can be used to calculate the dielectric function ϵ(ω) (Equation 4), which is related to the imaginary part of the refractive index, k.

$$\begin{matrix}ϵ ( ω ) = 1 + {χ}_{D} ( ω ) + {\sum }_{j = 1}^{n} {χ}_{Lj} ( ω ) & ( 4 ) \\ ϵ ( ω ) = {ϵ}_{1} ( ω ) + i {ϵ}_{2} ( ω ) & ( 5 ) \\ k ( ω ) = \frac{1}{\sqrt{2}} {( - {ϵ}_{1} ( ω ) + \sqrt{{{ϵ}_{1} ( ω )}^{2} + {{ϵ}_{2} ( ω )}^{2}} )}^{\frac{1}{2}} & ( 6 ) \\ α = \frac{2 k ω}{c} & ( 7 )\end{matrix}$$

The attenuation coefficient α (Equation 7) can be calculated from k, the frequency of light ω, and the speed of light c. (as described in Fox, M. Optical properties of solids; Oxford university press: 2010; Vol. 3).

The fit shows local maxima in attenuation at 360 nm and 520 nm in agreement with the JDOS and the experimental data. The magnitude of the attenuation coefficient predicted by the Drude-Lorentz model only differs from that of inventive 2D flakes by a factor of three. It was noted that because the reflectivity data used to make the fit to the Drude-Lorentz model only measured to 350 nm as a high energy bound, the damping term that describes the higher energy Lorentz component is subject to error; as a result, it is believed that the attenuation coefficient calculated from this fit is likely overstated at 360 nm.

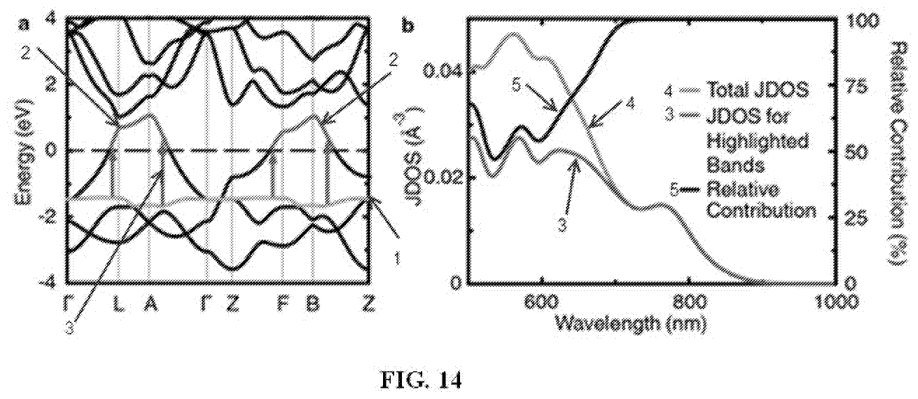

Additionally these data was compared to the JDOS of Ca₂N calculated from the band structure (FIG. 14(a)). The JDOS accounts for direct transitions from unfilled states to filled states as illustrated by dark blue arrows. Interestingly, transitions from the flat band around −1.7 eV to the unfilled states in the conduction band constitute a large portion of the total JDOS (FIG. 14(b)).

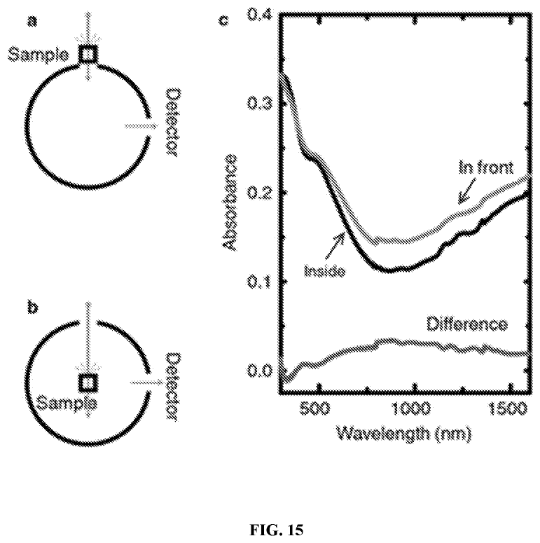

The experimental near IR data shows attenuation at wavelengths longer than 800 nm. Since the described experiment measures the transmittance of light, the attenuation is a combination of light scattering and absorbance despite made attempts to minimize the scattering component by using an integrating sphere. To try to qualitatively understand whether the long-wavelength response is dominated by scattering or absorbance, the transmittance with 1-cm quartz cuvette inside the integrating sphere and at the front of the integrating sphere was measured (FIG. 15). The wavelength was only measured to 1,600 nm because the solvent, 1,3-dioxolane, absorbs too strongly in the NIR with a 1-cm cuvette to yield measurable signals.

The Drude-Lorentz model predicts a minimum in effective attenuation around 800 nm in excellent agreement with the described data. In the Drude-Lorentz model, the impinging light is either scattered from the surface or attenuated by electron scattering events inside of the particle.

It was shown that the described measurements seem insensitive to the distribution of particle shapes and sizes. Without controlling for the size and shape of the particle and even with centrifuging at different speeds the long-wavelength response is consistent in all measurements. Therefore, the near IR response could have contributions from Drude absorbance and plasmonic signals.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A crystalline electride comprising:
at least one positively charged layer comprising at least one alkaline earth metal subnitride represented by a formula A₂N, wherein A comprises Mg, Sr, Ba, Ca, or a combination thereof, and one or more layers of anionic electrons; and
having a thickness from greater than 0 nm to about 50 nm.

2. The electride of claim 1, wherein the one or more layers of anionic electrons form a surface electron gas surrounding at least one positively charged layer.

3. The electride of claim 1 comprising two or more positively charged layers and one layer of anionic electrons disposed in interlayer space between the two or more positively charge layers.

4. The electride of claim 1, comprising three positively charged layers and two anionic electrons layers disposed in interlayer space between the three positively charge layers.

5. The electride of claim 1, wherein the anionic electrons are found in a two-dimensional plane.

6. The electride of claim 1, wherein the anionic electrons are present in a stoichiometric relation with the positively charged layers to ensure net neutrality of the electride.

7. The electride of claim 1, wherein the anionic electrons are at least partially delocalized as a two dimensional electron gas.

8. The electride of claim 1, having a surface area from about 20 to about 2,500 m²/g.

9. The electride of claim 1, wherein the crystal structure is a hexagonal crystal with an interlayer spacing of about 1.5-5.0 A.

10. The electride of claim 1, wherein the crystal structure is a hexagonal crystal having aperiodicity in the z-direction.

11. The electride of claim 1, wherein the electride is present as a film.

12. The electride of claim 11, wherein the film comprises a single flake.

13. The electride of claim 1, wherein the electride is present as a suspension.

14. The electride of claim 12, wherein the film has a length and a width of at least one order of magnitude larger than the thickness.

15. The electride of claim 12, wherein the film has an aspect ratio of at least about 1:10 or a lateral size of at least 20 nm

16. The electride of claim 1, wherein the electride has an electrical conductivity from about 100 to about 1×10⁷ S/cm.

17. The electride of claim 1, having a transmittance greater than about 10% to about 100%.

18. The electride of claim 17, having a transmittance of 97%.

19. The electride of claim 1, having a sheet resistance of from about 1 to about 10 Ohm/sq.

20. The electride of claim 17, having a sheet resistance of about 4 Ohm/sq.

21. The electride of claim 1, wherein a binding energy in the layered component is greater than 0 to about 3.0 J/m².

22. The electride of claim 1, further comprising a solvent that does not substantially react with the crystalline electride for a period of time of at least 48 hours.

23. The electride of claim 22, wherein the solvent comprises 1,3-dioxolane, dimethyl carbonate, dimethoxyethane, benzene, N-methyl-2-pyrrolidone, hexane, ethylene carbonate, propylene carbonate, ionic liquids, or a combination thereof.

24. A composition comprising:
(a) at least one positively charged layer comprising at least one alkaline earth metal subnitride represented by a formula A₂N, wherein A comprises Mg, Sr, Ba, Ca, or a combination thereof, and one or more layers of anionic electrons; and
(b) a solvent, wherein the crystalline electride does not substantially react with the solvent for a period of time of at least 48 hours.

25. The composition of claim 24, wherein the solvent comprises 1,3-dioxolane, dimethyl carbonate, dimethoxyethane, benzene, N-methyl-2-pyrrolidone, hexane, ethylene carbonate, propylene carbonate, ionic liquids, or a combination thereof

26. The composition of claim 24, wherein the solvent does not comprise 1,4-dioxane or tetrahydrofuran.

27. The composition of claim 24, wherein the crystalline electride has a thickness from greater than 0 nm to about 50 nm.

28. The composition of claim 24, wherein the electride has a surface area from about 20 to about 2,500 m²/g.

29. A method comprising:
(a) contacting a compound represented by a formula A₂N, wherein A comprises Mg, Sr, Ba, Ca, or a combination thereof, with a solvent that does not substantially react with the solvent for a period of time of at least 48 hours; and
(b) exfoliating a crystalline electride comprising at least one positively charged layer comprising at least one alkaline earth metal subnitride represented by a formula A₂N, wherein A comprises Mg, Sr, Ba, Ca, or a combination thereof, and one or more layers of anionic electrons.

30. The method of claim 29, wherein the crystalline electride has a thickness from greater than 0 nm to about 50 nm.

31. The method of claim 29, wherein the electride has a surface area from about 20 to about 2,500 m²/g.

32. The method of claim 29, wherein the solvent comprises 1,3-dioxolane, dimethyl carbonate, dimethoxyethane, benzene, N-methyl-2-pyrrolidone, hexane, ethylene carbonate, propylene carbonate, ionic liquids, or a combination thereof

33. The method of claim 29, wherein the solvent does not comprise 1,4-dioxane or tetrahydrofuran.

34. The method of claim 29, further comprising a step of separating the crystalline electride from the solvent.

35. A product produced by the method of claim 29.

36. An article comprising the electride of claim 1.

37. The article of claim 36, wherein the article comprises an energy storage device, an optoelectronic device, or a magnetic device.

38. The article of claim 36, comprising a flat panel display, a touch screen panel, a solar cell, a battery, an e-window, an electrochromic mirror, a heat mirror, a transparent transistor, a flexible display.
